(19) United States
(12) Patent Application Publication
(10) Pub. No.: US 2023/0274269 A1
(43) Pub. Date: Aug. 31, 2023

(54) APPARATUS AND METHODS TO DEFINE AND USE BEARER TOKENS AND CERTIFIED TOKENS AND APPLICATIONS USING BEARER TOKENS AND CERTIFIED TOKENS

(71) Applicant: Geeq Corporation, Waterloo (CA)

(72) Inventors: John P. CONLEY, Brentwood, TN (US); Stephanie A. So, Brentwood, TN (US); Lun-Shin YUEN, Palo Alto, CA (US)

(21) Appl. No.: 18/131,504

(22) Filed: Apr. 6, 2023

Related U.S. Application Data
(63) Continuation of application No. PCT/US2021/032500, filed on May 14, 2021.

(51) Int. Cl. G06Q 20/38; G06Q 20/40; G06Q 20/02

(52) U.S. Cl. CPC G06Q 20/3827; G06Q 20/02; G06Q 20/4014

(57) ABSTRACT

Methods, apparatus and techniques are disclosed to define and use bearer token records to transfer a crypto asset from a sending account and where a secret is required to be provided as a proof of possession of the bearer token to complete the transfer to a receiving account. Certified bearer tokens are locked for later transfer to a defined receiving account at generation. Lockable bearer tokens are lockable after generation via a second secret. Bearer token records may be expired to revert the crypto asset to the sending account if not completed using the secret. Bearer token records are implementable on a blockchain. Bearer tokens of small denomination crypto assets are useful for various transactions such a streaming or other online services. A computing device provides a change purse to carry and use bearer tokens. Multiple signature accounts and payment transactions are provided for crypto assets.

### CROSS-REFERENCE

This application is a continuation of PCT International Application No. PCT/US2021/032500 filed 14 May 2021 and entitled, “Apparatus and Methods to Define and Use Bearer Tokens and Certified Tokens and Applications Using Bearer Tokens and Certified Tokens”, the entire contents of which are incorporated herein by referenced. PCT/US2021/032500 claims priority to U.S. Application No. 17/066,375, filed Oct. 8, 2020 and entitled “Apparatus and Methods to Define and Use Bearer Tokens, Certified Tokens and Applications Using Bearer Tokens and Certified Tokens”, the entire contents of which are incorporated herein by reference.

### FIELD

The present disclosure relates to computer networks, crypto-based assets and distributed ledgers, namely blockchains and more particularly to apparatus and methods to define and use bearer tokens, certified tokens and applications using bearer tokens and certified tokens.

### BACKGROUND

Crypto-assets such as coins exist in records maintained in a distributed ledger based on a consensus mechanism performed by nodes of a computer network. Distributed ledgers may be public or private and are typically defined as a blockchain. An example of such a public ledger and mechanism is the Bitcoin blockchain (the status of Bitcoin a trademark for financial services is unclear). Other examples of blockchains include the Ethereum™ blockchain (a trademark of Stiftung Ethereum (Ethereum Foundation)) and a Geeq™-based blockchain such as a GeeqChain (Geeq and GeeqChain are a trademarks of Geeq Corporation). Authority to deal with tokens on a blockchain rests with holders of respective encryption keys, typically arranged in a private key and a public key pairing. A private key enables the holder thereof to sign a request to perform a particular transaction (in accordance with the rules of the chain) dealing with an asset in the blockchain where the asset is registered at an address associated with the private key. Holding a private key gives control over transferring crypto assets out of the address. If a private key is lost, it is difficult to regenerate - it is not practically derivable from the public key. The assets at the address are orphaned. Cryptocurrency wallets of various types are useful to store encryption keys and enable transactions. Other storage paradigms are also known, having varying degrees of security.

There can be reluctance for some persons to engage in blockchain transactions. The use of crypto-assets can be more onerous than using cash (e.g. a fiat currency), which is easily traded. For example, people may desire not to enroll or otherwise establish keys to use a particular blockchain. Traditional processes to authorize a cryptographic transaction may be intensive and burdensome.

There is a desire then to be able to transfer (e.g. use) crypto-assets with less friction.

### SUMMARY

In accordance with embodiments, methods, apparatus and techniques are disclosed to define and use bearer token records to transfer a crypto asset from a sending account and where a secret is required to be provided as a proof of possession of the bearer token to complete the transfer to a receiving account. Certified bearer tokens are locked for later transfer to a defined receiving account at generation. Lockable bearer tokens are lockable after generation via a second secret. Bearer token records may be expired to revert the crypto asset to the sending account if not completed using the secret. Bearer token records are implementable on a blockchain. Bearer tokens of small denomination crypto assets are useful for various transactions such a streaming or other online services using streaming payments. Provided (e.g. as computing devices, etc.) are a change purse and IoT wallet from which to pay using bearer tokens. Various user interfaces and uses are presented.

Further provided are multiple signature accounts and payment transactions for crypto assets.

In an embodiment, there is provided a first method. The first method comprises: providing transaction data for performing a transaction by a transaction network to define a bearer token record. The transaction data comprises: a sending account maintained by the transaction network from where the asset is to be transferred; and a release hash digest computed from a release secret to associate with the record. The bearer token record is closed and its value conveyed to another account by providing the release secret to the transaction network for use to match with the release hash and complete a transfer of the asset to a receiving account maintained by the transaction network.

In an embodiment, the method comprises communicating the release secret to a receiver for providing to complete the bearer token record and transfer the asset to the receiving account. The release secret may be defined as any of text and an encoded image.

In an embodiment, the method comprises comprising defining the transaction data. In an embodiment, the method comprises generating the release hash digest from the release secret to define the transaction data.

In an embodiment, the transaction to generate the bearer token record transfers the asset from the sending account to the bearer token record associated with the hash digest. In an embodiment, the transaction data includes expiry data to establish an expiry time associated with the bearer token record at which expiry time the asset reverts to the sending account if the bearer token record is yet to be completed using the release secret.

In an embodiment, the receiving account is maintained by the transaction network.

In an embodiment, the transaction network requires no providing of the receiving account to generate the bearer token record.

In an embodiment, the bearer token record comprises a certified token record associated at generation of the certified token record with the receiving account; and the transaction data further comprises the receiving account to which the asset is to be transferred.

In an embodiment, the bearer token record comprises a lockable bearer token record associated with a second hash digest; the transaction data further comprises the second hash digest computed from a holding secret for locking the lockable bearer token record to the receiving account, wherein to complete the locking requires providing to the transaction network the holding secret and account information for the receiving account to lock the lockable bearer token record so that only a single agent is enabled to complete the lockable bearer token record.

In an embodiment, the transaction is signed by a private key associated with the sending account.

In an embodiment, there is provided a second method. The second method comprises: communicating, to a transaction network, transaction data for a transaction to complete a bearer token record to transfer an asset to a receiving account, the bearer token record and receiving account maintained by the transaction network. The bearer token record is associated with: the asset to be transferred; and a release hash digest computed from a release secret. The transaction data comprises the release secret for use to match to the release hash digest to complete the transfer.

In an embodiment, the bearer token record is further associated with a sending account from where the asset was received for the bearer token.

In an embodiment, the second method comprises receiving the release secret for providing to complete the bearer token record.

In an embodiment, the release secret is defined as any of text and an encoded image.

In an embodiment, the transaction data further includes account information to determine the receiving account.

In an embodiment, the bearer token record comprises a certified token record; and the certified token record is further associated with the receiving account at generation of the certified token.

In an embodiment, the bearer token record comprises a lockable bearer token record; and the lockable bearer token record is further associated at generation of the lockable bearer token record with a second hash digest computed from a holding secret for subsequently locking the lockable bearer token record to the receiving account maintained by the transaction network; and the method comprises: communicating locking transaction data to lock the lockable bearer token record, the locking transaction data comprising the holding secret and account information for the receiving account so that only a single agent is enabled to complete the lockable bearer token.

In an embodiment, the transaction is unsigned by a private key associated with the receiving account maintained by the transaction network to which the asset is to be transferred.

In an embodiment of the first method or the second method, the transaction network processes transactions and stores transaction records including bearer token records in accordance with a blockchain consensus protocol. In either such embodiment, the asset is a crypto asset maintained by the transaction network.

In an embodiment of the first method or the second method, the asset comprises an amount of a cryptocurrency or other crypto-asset defined to satisfy a micro-transaction.

Computer device and computer program product aspects are correspondingly associated with any of the method aspects herein and vice versa. A computer program product comprises a non-transitory storage device storing instructions for execution by a processing unit and which when executed configures a computing device to perform a method. A computing device comprises components comprising circuitry such as processing unit, non-transitory storage, etc. The circuitry is configured using software or other approaches (hardwiring, etc.) to perform methods and or provide functions and features.

In an embodiment, there is provided a computing device comprising circuitry configured to provide transaction data for performing a transaction by a transaction network to define a bearer token record. The transaction data comprises: a sending account maintained by the transaction network from where the asset is to be transferred; and a release hash digest computed from a release secret to associate with the record. The bearer token record is completed by providing the release secret to the transaction network for use to match with the release hash and complete a transfer of the asset to a receiving account maintained by the transaction network.

In an embodiment, the computing device is further configured to provide a cryptocurrency wallet comprising cryptographic keys with which to manage a blockchain account, the keys useful to define the sending account and sign the transaction. In an embodiment, the cryptocurrency wallet provides: an interface to receive release secrets; and a hash function to compute release hash digests from release secrets to define transaction data for transactions to generate bearer token records. In an embodiment, the cryptocurrency wallet provides an interface to communicate the release secret. In an embodiment, the cryptocurrency wallet provides an interface to receive a release secret for a bearer token record previously generated by the transaction network and the computing device is configured to communicate to the transaction network completing data for a completing transaction to complete the bearer token record, the completing data comprising the release secret for the bearer token record previously generated and receiving account information.

These and other aspects are apparent to a person of skill in the art.

### BRIEF DESCRIPTION OF THE DRAWINGS

FIG. 1 is an illustration of a network system of a plurality of computing devices in accordance with an embodiment.

FIGS. 2A and 2B are block diagrams of data elements at different times in accordance with an embodiment.

FIGS. 3A, 3B, 4A and 4B are flowcharts of operations for computing devices of FIG. 1 in accordance with an embodiment.

FIG. 5 is a block diagram of a computing device in accordance with an embodiment.

FIG. 6 is an illustration of a bearer token representation printed on a substrate in accordance with an embodiment

FIGS. 7A and 7B are illustrations of a computing device implementing a highly accessible wallet and change purse in accordance with respective embodiments.

FIG. 8 is a flowchart of operations for a computing device of FIGS. 7A or 7B in accordance with an embodiment.

FIG. 9 is an illustration of a computing device showing a user interface to communicate bearer transaction data to facilitate a payment.

FIG. 10 is a flowchart of operations for the computing device of FIG. 9 in accordance with an embodiment.

FIG. 11 is an illustration of a computing device showing a user interface to authorize to communicate bearer transaction data to facilitate a payment.

FIG. 12 is a flowchart of operations for the computing device of FIG. 11 in accordance with an embodiment.

FIG. 13 is an illustration of a computing device defining an Internet of Things device configured to use bearer tokens to facilitate a payment for blockchain services.

FIG. 14 is a flowchart of operations for the computing device of FIG. 13 in accordance with an embodiment.

FIG. 15 is an illustration of a network system of a plurality of computing devices of in accordance with an embodiment.

FIGS. 16A and 16B are flowcharts of respective operations for respective computing devices of FIG. 15 in accordance with an embodiment.

FIG. 17 is an illustration of a computing device providing an interface to communicate bearer token data as petty cash to certified payee in accordance with an embodiment.

FIG. 18 is a flowchart of operations for a computing device in accordance with an embodiment.

FIG. 19 is an illustration of a network system of a plurality of computing devices in accordance with an embodiment.

FIGS. 20A, 20B, 21A, 21B, 21C, and 21D are flowcharts of respective operations of computing devices of FIG. 19 in accordance with respective embodiments.

FIG. 22 is an illustration of a network system of a plurality of computing devices in accordance with an embodiment.

FIGS. 23A and 23B are flowcharts of respective operations of a computing device for multiple signature transactions in accordance with an embodiment.

### DETAILED DESCRIPTION

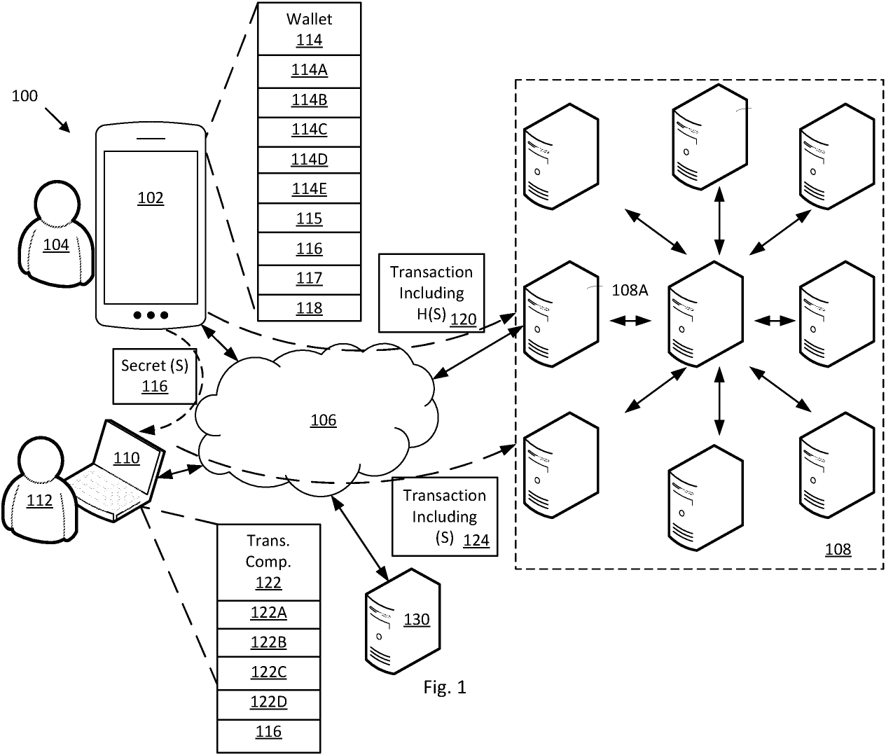

FIG. 1 is an illustration of network system 100 of a plurality of computing devices, in accordance with an embodiment. Network system 100 comprising a first user device 102 operated by a first user 104, a communication network 106, a transaction network 108 and a second user device 110 operated by a second user 112.

Also shown is a server device 130, a computing device providing a service over network 106 such as to any of devices 102 and 110. Server device 130 is not restricted to providing services to consumers or individuals. In an embodiment, services include business to business services such as is conducted with other servers or computing devices (not shown). In accordance with an embodiment, server device 130 provides a service (e.g. some or all of its services) in exchange for payment. In accordance with an embodiment, payment is accepted via transaction network 108. In accordance with an embodiment, other payment methods are accepted (not shown). In an embodiment, a service provided comprises an on-line gaming service (e.g. multiplayer and/or single player). In an embodiment, a service provided comprises an on-line streaming service (e.g. audio streaming, video streaming, live sports streaming, e-sports streaming, etc.) In an embodiment, a service provided comprises a social media service (e.g. to share any of text, images, audio and video). In an embodiment, a main or primary service includes additional services or features. As an example, an add-on feature in a social media service may be a filter for annotating (applying an effect to) an image and/or video. In a gaming service, an add-on or in-game feature may be a code for changing gameplay (e.g. a cheat code), an armor or weapon upgrade, additional in-game tokens/coins, etc.) In an embodiment, the service provided comprises internet search services. In an embodiment, the service provided comprises an e-commerce service such as to purchase a product.

The communications network 106 couples the devices for communication. Communication network 106 is simplified. In an embodiment it comprises a combination of any of public and private networks communicating using various protocols and means, whether wired or wireless. In an example, communication network 106 comprises the Internet.

In the embodiment, first user device 102 comprises a mobile device, such as a smartphone (shown), laptop, automobile, etc. Other computing device form factors are contemplated and need not be configured as a mobile device. First user device 102 comprises a wallet 114 (e.g. a mobile wallet) for facilitating transactions via the transaction network 108. In an embodiment, the mobile wallet 114 comprises a cryptocurrency wallet to manage keys 115 for cryptocurrency transactions.

In an embodiment, mobile wallet 114 provides an interface 114A to receive a secret (e.g. S) 116; an interface 114B to receive an amount 117; a hash function (e.g. H) 114C to compute a hash digest (e.g. H(S)) 118 of the secret 116 and an interface 114D to communicate the secret 116, for example to second user device. Wallet 114 further provides an interface 114E to communicate a transaction 120, such as further described, including account information for a sending account, the amount 117 and the hash digest 118 to transaction network 108.

In the embodiment, second user device 110 comprises a mobile device, such as a laptop. Other computing device form factors are contemplated and second user device 110 need not be configured as a mobile device. Second user device 110 comprises a transaction configuring component 122 for facilitating transactions via the transaction network 108. In an embodiment, the transaction configuring component 122 is a browser component (e.g. a plugin or add-on, etc.) for Web-based communications. In an embodiment the transaction configuring component 122 is a wallet (not shown) such as a cryptocurrency wallet to manage keys (not shown) for cryptocurrency transactions.

In an embodiment, transaction configuring component 122 provides an interface 122A to receive a secret (e.g. S) 116 such as from first user device 102; and an interface 122B to define and communicate a transaction 124 comprising the secret S, such as further described, to transaction network 108. In an embodiment, transaction component 122 has a private/public key pair generator 122C and a key interface 122D for managing/using the keys.

In an embodiment, transaction network 108 comprises a plurality of interconnected nodes (each comprising respective computing devices) including a representative node 108A. In an embodiment, the transaction network comprises a network implementing a distributed ledger providing a blockchain in accordance with a blockchain consensus protocol executed by the nodes to process transactions. The blockchain maintains accounts, for example, associated with keys. Cryptocurrency (e.g. coins native to the blockchain) are provided and maintained by the blockchain. Amounts of coins are storable to and transferable between the accounts in accordance with rules or protocols executed by the nodes for blockchain transactions. In an embodiment, the blockchain records other crypto assets and facilitates transfer of same such as between accounts controlled by respective private keys.

In an embodiment transaction network 108 comprises a payment network, which may be a blockchain network for making payments via coin, for example. In an embodiment transaction network 108 is a payment network but is not a blockchain network.

In an embodiment, each of the nodes of transaction network 108 has a same configuration for implementing the blockchain. Though node 108A is shown communicating with each of first and second computing devices 102 and 110, other nodes of transaction network 108 may do so in the embodiment.

In an embodiment, the transaction network implements a GeeqChain in accordance with consensus and transactions protocols of Geeq Corporation such as described in WO2019/142049 dated 25 Jul. 2019, entitled “BLOCKCHAIN METHODS, NODES, SYSTEMS AND PRODUCTS” incorporated herein in its entirety. The GeeqChain provides and maintains Geeq coins – GEEQS™.

In an embodiment, such as where transaction network 108 maintains a blockchain, a first node (e.g.108A) of the transaction network is in communication with a computing device (e.g. 102) outside the payment of the transaction network 108 where the first node receives transaction data from the computing device such as for a transaction as further described. The transaction data comprises an identification of the first node (in an embodiment). The first node communicates the transaction data within the transaction network to facilitate processing of the transaction by other nodes maintaining the blockchain.

### Bearer Tokens and Certified Tokens

In accordance with embodiments and techniques herein, bearer tokens (sometimes “BTs” or a “BT”) and certified tokens (sometimes “CTs” or a “CT” or a “bearer certificate”) may be likened to cryptographic equivalents of cash and certified checks, respectively. Both BTs and CTs can be represented electronically (e.g. by text files or other data types) or non-electronically (e.g. as text or image visible on a substrate such as paper stock), which can be used to pass value (e.g. a crypto asset) from a transferor (payer or sender) to a transferee (payee or receiver) without the direct use of a blockchain or other centralized or decentralized data or financial intermediary. These tokens can be stored as text files, encoded images such as a two dimensional or three dimensional barcode (e.g. a QR Code™, a trademark of Denso Wave Incorporated, Japan), on credit, debit, or gift cards, in directories accessible to browsers through plugins or on mobile devices through apps (applications), among other ways. It is understood that QR Codes and other barcodes are useful to encode text data in accordance with the respective protocols therefor.

A bearer token is based upon knowledge and use of a secret. Bearer token data comprises a release hash digest that is generated by applying a hash function to a data value (e.g. a pre-image) chosen by a token creator that the creator keeps secret. Examples hash functions include SHA-3 384/256, RIPEMD-160, BLAKE2 and BLAKE3.

The creator may comprise the transferor or another acting on behalf of the transferor. To create a bearer token record on the blockchain, in an embodiment, the hash digest is provide with an associated value (e.g. an amount of a cryptocurrency maintained by the blockchain) associated with an address (e.g. as sending account) controlled by the token creator. If the transaction to generate the bearer token record is valid, in an embodiment, the blockchain creates a bearer token record with the digest and the amount, transferring the amount from the sending account. The token creator (directly or indirectly) communicates the secret to a receiver. The receiver can use the secret to release the value from the bearer token record, for example, to a receiver account. A transaction is defined including the pre-image and a receiver account designated by the receiver and sent to the blockchain to cash the bearer token. The blockchain hashes the secret and locates a matching bearer account record, if available, and in response closes the record and transfers the amount to the designated receiver account.

In an embodiment, the creator of the bearer token could choose any word, phrase, or number as a pre-image and then include the hash digest in the create bearer token account transaction. This has the advantage of being easy to remember and pass on to the receiver. On the other hand, it has the disadvantage that collisions are possible as other users happen to use the same word as a pre-image. The blockchain may be configured with a protocol to handle secret collision - e.g. where a bearer token record exists and a second request to add a record is received having the same hash digest. In an embodiment, the blockchain is configured to refuse a new create bearer token record transaction if an existing bearer token record has the same hash digest. In an embodiment, the blockchain is configured not to refuse a new create bearer token record transaction if an existing bearer token account record has the same has digest. Rather, when the secret is presented, all matching BT records are cashed. Other protocols may be adopted to handle secret collision scenarios.

In an embodiment, random numbers with at least 32 bytes of data are used as secrets. In an embodiment, such secrets are generated as they are needed such as by the sender’s blockchain wallet, for example, based on a seed value. In such a manner, wallet operations would allow a user to request that the wallet generate e.g. 500 bearer token pennies automatically simply by providing authorization to fund them with an existing account (and providing access to the associated private key). The wallet would create 500, one cent, BTs by creating 500 create BT record transactions each with a respective hash of one of the 500 randomly generated numbers. These pre-image random numbers would then be stored in the wallet so that the user could spend the BTs as needed. In an embodiment, the user never has to be aware of the pre-image random numbers or be involved in creating them but has access to them via the wallet to share with a receiving party to facilitate cashing a BT. A wallet may have an interface to view and/or communicate a BT comprising the secret.

In accordance with the embodiments and techniques herein, a native blockchain coin only exists as a balance in a ledger account. It has no other embodiment. When a coin is given from one user (sender) to another (receiver), for example, the sender creates an applicable transaction, and the blockchain moves a coin amount (balance) to the receiver’s account. In contrast, when a bearer token record is created, the blockchain moves a coin balance to a ledger entry (a form of blockchain record) that is controlled by a pre-image (the secret), rather than a private key, once the ledger entry is created. Any coin balance is moved into an “account” without an account number (the ledger entry) held in a kind of escrow waiting for transfer back to a regular account (e.g. by the sender using the secret to cash the token or by an optional expiry time as further described). The pre-image is the token needed to take control of the coins in a bearer token record. As referenced herein, a bearer token is the pre-image (secret), which may be represented (e.g. as a bearer token representation herein) in a digital or physical embodiment, off of the chain, of the coins in escrow.

In an embodiment, certified tokens comprise similar data to BTs but are further secured as described below.

BTs are especially well-suited for micro-transactions, a financial transaction such as for a product or service costing a low dollar value (which in an embodiment is less than US$ 10 or, in an embodiment, is less than $5, or in an embodiment less than $1 ranging down to fractions of a penny (or their equivalent values in another currency). In an embodiment, bearer tokens can be created in larger denominations. Certified tokens are especially well-suited for secure, trustless transfer of larger amounts such as for a house or automobile purchase, but can also be created in smaller denominations. In an embodiment, these techniques particularly leverage blockchains capable of high volumes of transactions at very low cost such as GeeqChain.

### Bearer Tokens

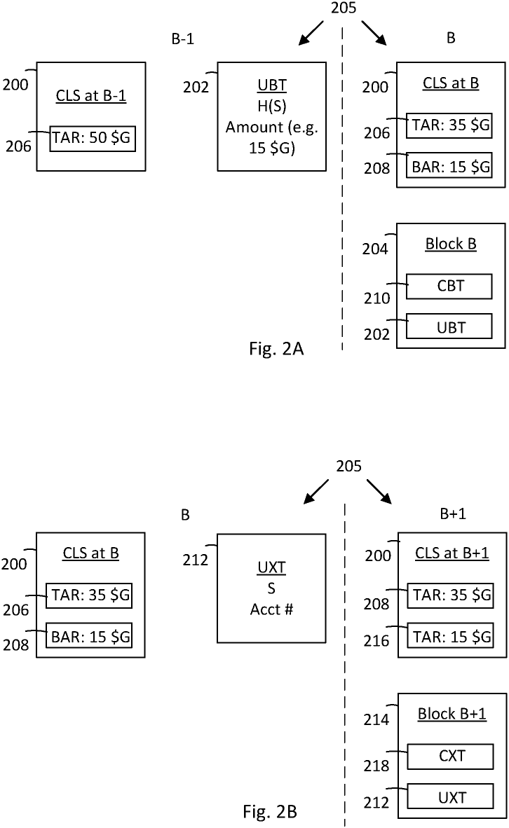

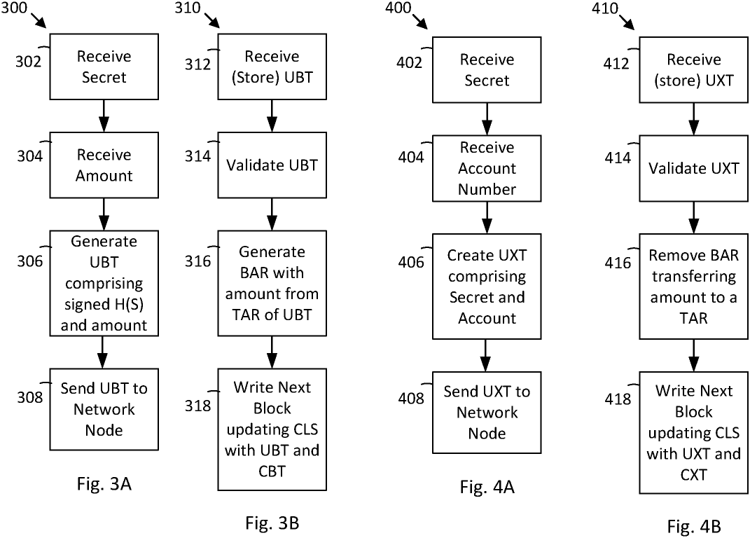

In accordance with an embodiment, a bearer token is implemented by establishing bearer token transaction rules that support the creation and use of such a token on a blockchain. FIG. 2A is a block diagram illustrating data elements 200, 202, and 204 at different times 205 (e.g. referenced as block times B-1 and B) in accordance with an example transaction to generate a bearer token record. FIG. 2B is a block diagram illustrating data elements 200, 212, and 214 at different times 205 (e.g. referenced as block times at B and B+1) in accordance with an example transaction to cash a bearer token record. FIGS. 3A and 3B are flowcharts of operations 300 and 310 such as for first computing device 102 and any of nodes of transaction network 108 to process a transaction to generate a bearer token record. FIGS. 4A and 4B are flowcharts of operations 400 and 410 such as for second computing device 110 and any of nodes of transaction network 108 to process a transaction to cash a bearer token record.

By way of example, in the case of a GeeqChain implemented by transaction network 108, the chain’s Current Ledger State (CLS) 200 stores a plurality of Token Account Records (TARs). A particular TAR 206 is associated with an amount of Geeqs ($G such as 50 $G) at a time represented by current block B-1. In the present example, TAR 206 is associated to keys 115 of user device 102 operated by first user. For convenience, in relation to example transactions herein, first user 104 is referenced as Alice and second user 112 is referenced as Bob.

In the GeeqChain, in accordance with the embodiment, a transaction to establish a bearer token is called an Unconfirmed Create BAR Transaction (UBT) 202. Alice, via user device 102 and interfaces 114A and 114B, inputs a hash of a secret or the secret itself which is then hashed (e.g. received by device 102 at step 302) and an amount 117 (e.g. 15 $G) (e.g. received by device 102 at step 304). In an embodiment, the amount 117 is a positive value in accordance with the protocol.

Wallet hash function 114C computes the hash digest 118 from the secret 116. Alice further uses wallet 114 to generate and sign UBT 202 (comprising the transaction data and performed at step 306) using her private key - one of keys 115. Interface 114E is used to communicate the UBT 202 to node 108A and is performed by device 102 at step 308. Transaction 120 is an example of a UBT.

With reference to FIGS. 2A and 3B, the UBT 202 is received at step 312. It is understood that receiving data operations comprises storing data operations, to store data at least temporarily. The validity under Geeq’s consensus protocol is determined (step 314) and then a Bearer Token Account Record (BAR) 208 is generated (step 316) in the chain’s Current Ledger State (CLS) at time B. The amount from the UBT 202 is removed from Alice’s sending account –TAR 206 – in CLS 200 at time B. At the same time B, both the UBT 202 and a Confirmation of Create BAR Transaction (CBT) 210 are added to the next block 204 (appended to the chain (step 318). As such there is a request to create/generate (UBT), a confirmation that the request is valid (CBT) and a record in the ledger of the bearer token – the BAR.

More generally, any blockchain, ledger, or other provider could create a record that includes a release hash digest that controls the transfer of the value attached to a bearer token to a designated account (a receiver account). In accordance with an embodiment, in the interim, prior to a transfer to the designated account, the amount is transferred out of the sending account to a record on the blockchain. The record is associated with the secret (the BT), and not an account controlled by a particular private key per se. Any subsequent transaction that presents the secret is enabled to cash the token and direct the transfer of the amount to a designated account.

In accordance with an embodiment, a way of using a bearer token is also to submit a specialized transaction to a blockchain. With reference to FIGS. 2B and 4A, in the case of GeeqChain, this is called an Unconfirmed close BAR Transaction (UXT) 212. Bob receives secret (S) 116 from Alice, for example, via a communication from device 102 to device 110, where Alice uses interface 114D. In an embodiment, Alice communicates secret (S) 116 in another manner.

Bob uses transaction component 122 at step 404 to provide account information to determine a designated account for transaction network 108. In an embodiment the account information is a public key with which to generate an address. In an embodiment, it is an existing address on the chain. In an embodiment, transaction component 122 is a component of a wallet, for example. In an embodiment, Bob has no prior private/public key pair (or desires a new one) and transaction component 122 generates one on the fly for Bob (e.g. using key generation protocols, a mnemonic (seed phrase), etc.) The public key is used to define the designated address for the UXT 212.

At step 406, transaction component 122 generates a UXT 212. At step 408, transaction component 122 communicates UXT 212 to node 108A. Transaction 124 is an example of a UXT.

With reference to FIGS. 2B and 4B, the UXT 212 is received (including storing) at nodes of the transaction network 108 (e.g. via node 108A) (step 412). The validity of the UXT 212 under the chain’s protocol is determined (at step 414). Then at the same time (e.g. at B+1): BAR 208 is zeroed out from the chain’s CLS 200 (e.g. the amount is zero, or the BAR itself is removed from the CLS) and the value represented by the bearer token (e.g. 15 $G) is added to the designated account – Bob’s TAR 216 (step 416).

At 418, both the UXT and a Confirmation of close BAR Transaction (CXT) are added to the next block appended to the chain. If Bob does not have an existing TAR on the chain instance where the BAR was created, a new TAR is created with the account information provided by Bob in his UXT and the token’s value is added.

In relation to step 414, to validate the UXT, in accordance with an embodiment, each node hashes the secret received and matches it to a BAR (e.g. an uncashed BAR) in the node’s CLS. If the BAR is not located, the UXT is not valid. By way of example, the BAR may have been previously cashed, the BAR was never generated, or the secret is not correct to match an existing BAR.

More generally, any blockchain, ledger, or other provider closes a record when presented with the correct pre-image (e.g. data comprising the secret) of the correct release hash digest that controls the transfer of the value attached to the bearer token to a designated account.

Transactions fees (e.g. an amount of token maintained by the blockchain) may be deducted when the BAR is opened and/or closed.

In an embodiment, there are a plurality of GeeqChains utilizing Geeq protocols and GeeqCoins. In the embodiment, the chains are federated, allowing transfers between chains. In an embodiment, Alice sends the UBT to a node on a chain where she has coins.

In an embodiment, the UXT comprises additional data to facilitate transaction processing. For example, the UXT identifies the applicable blockchain and may include other blockchain data to facilitate processing. For example, the UXT identifies a computing device associated with the blockchain (e.g. node 108A) (e.g. a node ID number, a node public key or account, and/or a node IP address), to initially receive the communication and introduce it to the nodes of the transaction network 108. In accordance with an embodiment data for a UXT is described below.

In an embodiment, a BAR is associated with an expiry time such that the amount transferred to the BAR reverts to a sending account at the expiry time if the BAR is not previously cashed using the secret. In an embodiment, Alice may provide expiry data as transaction data to establish the expiry time. In an embodiment the blockchain protocol automatically sets an expiry time. In an embodiment, an expiry time is relative to a number of blocks written after generation of the applicable BAR. Other time references may be used (e.g. relative to a calendar).

In accordance with an embodiment under the GeeqChain protocol, Table 1 shows particulars of a BAR 208.

TABLE 1

BAR - Bearer Token Account Record

| Data Item | Bytes |
|---|---|
| Amount in BAR | 6 |
| Creation Block | 4 |
| Last Transaction Block | 4 |
| Sending Account Number | 32 |
| Expiration Transaction Block | 4 |
| Release Hash Digest | 32 |
| Total Bytes | 82 |

In Table 1: Amount in BAR represents the amount of tokens or coins to be held in the BAR; Expiration Transaction Block represents the block number at which the funds revert to the sending account; Sending Account Number represents Alice’s TAR account number (e.g. sending account) so the funds can revert if the expiration block is reached; and release hash digest represents the hash digest of Alice’s release secret.

In accordance with an embodiment under the GeeqChain protocol, Table 2 shows particulars of a UBT 202.

TABLE 2

UBT - Unverified Create BAR Transaction

| Data Item | Bytes |
|---|---|
| Reference Number – Chain | 4 |
| Reference Number – Block Target | 4 |
| ID Number– Node Target | 2 |
| Amount to be placed in BAR | 6 |
| ID Number– User Transaction index | 2 |
| Sending Account Number | 32 |
| Public Key – Sending Account | 57 |
| Reference Number – Expiration Transaction Block | 4 |
| Release Hash Digest | 32 |
| Signature – BAR Creator | 114 |
| Total Bytes | 257 |

In Table 2: Amount to be placed in BAR represents the amount to be taken out of Alice’s TAR and placed in the BAR; Sending Account Number represents Alice’s TAR account number; Public Key – Sending Account, and Signature – BAR Creator represent: the public key associated with the sending account number and Alice’s signature of the transaction request which are needed to make the transaction valid; and Release Hash Digest represents the hash digest of Alice’s release secret. The other fields are metadata used to validate the transaction and create the BAR, in accordance with the embodiment.

In accordance with an embodiment under the GeeqChain protocol, Table 3 shows particulars of a UXT 212.

TABLE 3

UXT – Unverified Close BAR Transaction

| Data Item | Bytes |
|---|---|
| Reference Number – Chain | 4 |
| Reference Number – Block Target | 4 |
| ID Number– Node Target | 2 |
| ID Number– User Transaction index | 2 |
| Receiving Account Number | 32 |
| Release Hash Pre-image | 32 |
| Total Bytes | 76 |

In Table 3: Receiving Account Number: The account number that Bob wishes to have the BAR balance deposited to; and Release Hash Pre-image represents the only thing needed to make this transaction valid (i.e. the secret). The other fields are metadata used to validate the transaction and create the BAR, in accordance with the embodiment.

In an embodiment, a wallet (or other manner) is used to determine the transaction data such as for a UXT. The release pre-image is the only transaction data field value not available from public sources or through arbitrary choice of the creator of the UXT. The Reference Number – Chain comprises public information, which may be located via a search. It is public data that a given digest is on a specific chain. The other transaction data fields (Reference Number – Block Target; ID Number– Node Target; ID Number- User Transaction index; Receiving Account Number; are all chosen, in an embodiment, by the creator of the UXT. These other data fields do not need any input from the BAR creator. A wallet, understood as both a storage device and software including UI/UX, in an embodiment, is configurable to offer choice(s) for the data fields under a user’s control above.

In accordance with an embodiment under the GeeqChain protocol, Table 4 shows particulars of a CBT 210.

TABLE 4

CBT – Confirmation of Open BAR Transaction

| Data Item | Bytes |
|---|---|
| Hash – Unconfirmed Transaction | 32 |
| Amount – Fee Collection | 6 |
| Total Bytes | 38 |

In accordance with an embodiment under the GeeqChain protocol, Table 4 shows particulars of a CBT 210.

TABLE 5

CXT – Confirmation of Close BAR Transaction

| Data Item | Bytes |
|---|---|
| Hash – Unconfirmed Transaction | 32 |
| Amount – Fee Collection | 6 |
| Total Bytes | 38 |

In Table 4 and Table 5: Hash – Unconfirmed Transaction represents the hash of the entire valid UBT or UXT. This makes it unambiguous which UBT or UXT is approved as valid in the list of unconfirmed transactions in the block. And Amount – Fee Collection represents the amount deducted from the BAR balance to pay nodes for their validation services.

In accordance with the foregoing embodiments, the following is notable. No smart contract is needed to create or close the BAR. Bob does not need an account on the blockchain before attempting to cash or consume Alice’s BAR. With Alice’s secret alone, Bob may formulate a valid transaction to cash the BAR Alice created. The blockchain can use the account information provided with the transaction to define a new account, if necessary. Anyone who knows this secret, including Alice and anyone else she has told, can cash the token anonymously at any time. Any person or intermediary with an account on a given instance of a blockchain could create bearer token records securely on Alice’s behalf by having Alice provide hash digests and amounts and for each token desired, and then creating corresponding BARs on the chain instance. The intermediary could generate bearer token records for Alice for free or accept payment in cash, via credit or debit card, through an ACH or other electronic transfer, or any other means. Only Alice would know the secrets, and only Alice, or whomever she told the secret to, would be able to cash the token (e.g. its token record).

Fiat currency allows the anonymous transfer of value from one agent to another through giving possession of a physical object that represents value (a dollar bill or a nickel (or other currency equivalents thereto)) to another agent. The only proof that the receiver owns this value is the possession of the physical object. Bearer tokens function like cryptographic cash in that they allow value to be transferred anonymously through giving possession of a secret to another agent. Knowledge of the secret is the only thing required to prove that the receiver owns this value (e.g. has a right to deal with it in accordance with the protocol of the transaction network).

More generally, bearer tokens could be implemented in a variety of other ways. All that is required is that some intermediary promises to transfer something to another party when the first party provides the intermediary with a hash digest of a secret and the second party presents the pre-image of this secret. The party might be a bank or other financial institution, a payment intermediary such as PayPal™ (PayPal is a trademark of PayPal Inc.) or the VisaNet™ network (VisaNet is a trademark of Visa International Service Corporation), a retailer or wholesaler, a logistics or shipping company, a casino or cruise line, among others. The transfer items could include cryptocurrencies or tokens, fiat currency or balances, physical transfer of goods or services, or legal ownership or use rights, among others. In particular, ERC20 type native tokens on the Ethereum blockchain that exist through smart contracts or on Geeq’s application layer could use bearer tokens as a method of transfer.

### Security of Bearer Tokens

In an embodiment, the simple version of a bearer token has the property that the first agent to present to the pre-image receives the value represented by the token. This creates three possibilities: 1) the token’s creator tells the secret to only one agent and that agent is able to cash the token; 2) the token’s creator tells the secret to many agents and only the first to present it to the blockchain or other intermediary is able to cash it. All other receiving agents would find that the token had already been consumed; and 3) the token’s creator tries to cash the token herself, possibly at almost at the same time she tells the secret to its “intended” receiver. In effect, this results in a race between the creator and receiver to see who can present the pre-image to the intermediary or blockchain first.

The risk from case 2) is minimal since the receiver could easily check with the intermediary or blockchain to see if the token is still valid. This, however, does not solve the “race” problem described in case 3.

In an embodiment, a use case for bearer tokens is to transfer small amounts of value (micropayments). In an embodiment, this will be for streaming content or services such as access to games. In an embodiment, users will be logged in and will have repeated interactions with the service provider. This means that the first time a provider finds he has received an invalid token he can stop provision of services or delete the user’s account. Thus, the risk of loss from cases 2 and 3 is small while the gain to the sender is similarly small (e.g. where the bearer token value is only a few cents or equivalent thereto). In practice, this will minimize such fraud while providing a previously impossible way to accept micropayments with very low transactions fees. Risk still exists, however, and may be significant if large payments or transfers are contemplated.

With this in mind, described are two higher security variants of bearer tokens below.

### Certified Tokens

In accordance with an embodiment, a certified token is similar to a bearer token with one exception. CTs can only be cashed to the benefit of a single agent identified by a public key. That is, anyone can cash a CT, but the only possible receiver is the account associated with a specific public key.

In accordance with an embodiment, a way of creating a CT is to submit a specialized transaction to a block chain. In the case of a GeeqChain, in accordance with an embodiment this is called an Unconfirmed Create CAR Transaction (UCT). In the example, transaction data includes the release hash digest, the (coin) amount, the address from where the coin amount to be transferred is located and the address where the coin is to be transferred. The transaction is signed with the private key associated with the address from where the coin amount to be transferred is located. The validity under Geeq’s protocol is determined and then both the UCT and a Confirmation of Create CAR Transaction (CCT) are added to the next block appended to the chain. At the same time a Bearer Certificate Account Record (CAR) is created in the chain’s CLS.

In accordance with an embodiment, a way of using a CT is also to submit a specialized transaction to a blockchain. In the case of the GeeqChain, in accordance with an embodiment, this is called an Unconfirmed close CAR Transaction (UYT). Transaction data includes the secret pre-image which is compared (after hashing) to the release hash digest stored as some of the token’s data (in the bearer token’s account record). Here the transaction need not be signed. The validity under Geeq’s protocol is determined – comparing the hash of the secret to the stored hash – and then both the UYT and a Confirmation of close BAR Transaction (CYT) are added to the next block appended to the chain. At the same time, the Bearer Certificate Account Record (CAR) is zeroed out or removed from the chain’s CLS and the value represented by the token is added to the designated account.

In accordance with embodiments, as with bearer tokens, similar schemes both on and off blockchains in which value is locked to both a secret provided by the creator and a cryptographic identity chosen by the creator, are possible. Transactions fees could be collected at one or several points in this process.

The following describes an example of this process using a specific implementation of CTs, in accordance with an embodiment such as on a GeeqChain.

Alice has an account on an instance of a GeeqChain containing coins (GEEQs).

Alice creates a UCT that includes her account number, the value to be associated with the certified token, a hash digest of a secret known only to Alice, the public key of the designated receiver, and a private key signature of Alice authorizing the transfer of funds out of her account and onto the CT.

Alice sends the UCT to a node on the chain where she has coins.

If the UCT is valid under the chain’s protocol rules, the validation network approves the transaction and records this fact in the next block of the chain. Under Geeq’s protocol this requires including both the UCT and a CCT.

The validation network also updates the CLS to include a corresponding CAR.

To use the CT, Alice sends Bob the pre-image of the secret used to create the certificate.

Bob creates a UYT transaction that includes the pre-image. Like bearer tokens, this does not require an authorizing signature or that Bob have a preexisting account on the GeeqChain instance.

If the UYT is valid under the chain’s protocol rules, the validation network approves the transaction and records this fact in the next block of the chain. Under Geeq’s protocol this requires including both the UYT and a CYT.

The validation network also updates the CLS by: 1) Removing Alice’s CAR; 2) Adding the value in the CAR, less transaction fees, if any, to the TAR with the receiving address designated in the UCT/CAR; and 3) If the designated receiving address does not have a TAR on the chain, a new TAR is created and the token’s value is added.

In accordance with the foregoing embodiment, the following is notable. As describe with reference to bearer tokens, no smart contract is needed to create the CAR, and Bob does not need an account on the blockchain before he attempts to cash or consume Alice’s BAR. Bob, or the intended receiver, provides (directly or indirectly) Alice with a public key to create the CAR. This might be obtained from published or other known sources rather than directly from Bob.

To cash the CAR, Alice must provide Bob with the pre-image of her secret.

Anyone who knows this secret, including Alice and anyone else she has told, can cash the token anonymously at any time. However, the value on the CT can only be transferred to the public key account identified in the CAR and cannot be chosen by whomever cashes the CT.

In an embodiment, records on the blockchain are public. Prudently, parties such as Alice or Bob can check BAR and CAR data to verify the recording of tokens, amounts and for CTs, the designated recipient account.

Certified checks and money orders can allow the anonymous transfer of value from one agent to one specific agent through the act of giving possession of the check to this agent. Regardless of who presents the check, it can only transfer value to the agent named as the recipient on check. The check has no value to any other agent. Certified tokens function like cryptographic certified checks, in accordance with an embodiment, in that they allow value to be transferred to one specific agent identified by a public key through giving possession of a secret to this agent. Knowledge of the secret is enough to cash the check, but only the designated receiver can ever benefit from the value attached to the check.

As with BTs, CTs could be created and cashed in a variety of physical and virtual ways. CTs could be printed on paper, created on other physical or electronic media, or transmitted in a variety of file formats. It will be understood then that value owned by one agent is transferred to the control of specific public-private key pair on presentation of the correct pre-image of the creator’s secret to a blockchain or other intermediary.

### Lockable Bearer Tokens

In accordance with an embodiment, lockable bearer tokens (LBTs) are a variation on bearer tokens and/or of certified tokens, designed to solve the “racing” problem described hereinabove. Like bearer tokens, lockable bearer tokens can be cashed to the benefit of any agent, but they include a second secret that can be used to (temporarily) lock the token so that only a single agent can cash it while the lock is in place. When the hold secret is submitted, in effect, this turns the lockable bearer token into a certified token, for example, typically for a number of blocks (e.g. temporarily), until the release secret is provided. Only after this hold is placed, subsequently, the release secret is provided in another transaction which then pays the balance of the LAR to the account it was held to in hold transaction.

While the embodiments herein describe a choice or generation of a secret by the creator of the bearer token and its’ record, in an embodiment, a receiver originates the secret (or secrets in the case of a lockable bearer token) and provides sender with same. This embodiment does not prevent a racing problem but provides the receiver with an option regarding the secret, which may be preferred by the receiver.

In an embodiment, a receiver originates the secret (or secrets in the case of a lockable bearer token) and provides sender with the hash digest(s) for use to create the bearer token and its record. For example, the intended receiver gives the sender hash digest(s) which the sender then uses to create a bearer token, certified token or a lockable bearer tokens. In an embodiment, the receiver posts the digests publicly. In an embodiment, the receiver provides them at the request of the sender.

When receiving a hash digest from another, the sender creates the applicable token record but would not know the pre-image needed to cash it, as they typically could when the secret is originated by the sender. By using hash digests provided from a receiver, the receiver is in full control of the bearer token after it is created and so would not have to worry about the sender cashing it in advance. The receiver could then cash the token at any time (e.g. before an expiration) without concern the receiver would be beaten to it by the sender or anyone else. By using hash digests provided from a receiver, anonymity may be increased. When a bearer token or lockable bearer token is cashed, it is cashable to any account chosen by the receiver. (For a certified token, the receiver may also supply the account to the sender for use at record generation.) For example, in an embodiment, the receiver uses the token to pay another agent instead of cashing it directly to his own public key account. This would mean that the public key account that the token was paid to would not necessarily be the initial receiver of the bearer token.

In accordance with an embodiment, a way of creating a lockable bearer token is to submit a specialized transaction to a blockchain. In the case of the GeeqChain, in accordance with an embodiment, this is called an Unconfirmed Create LAR Transaction (ULT). Transaction data comprises that of bearer token data and a second hash digest as described further. The validity under Geeq’s protocol is determined and then both the ULT and a Confirmation of Create LAR Transaction (CLT) are added to the next block appended to the chain. At the same time a Lockable Bearer Token Account Record (LAR) is created in the chain’s CLS.

In accordance with an embodiment, a way of using a lockable bearer token is to submit two specialized transactions to a blockchain sequentially. First, the creator of the LAR must transmit a holding secret pre-image to the receiver. The receiver can then submit an Unconfirmed Hold LAR Transaction (UHT) that includes this secret along with a public key or address that he wishes to lock payment to. The validity under Geeq’s protocol is determined and then both the UHT and a Confirmation of Hold LAR Transaction (CHT) are added to the next block to append to the chain. Second, the creator of the LAR transmits a release secret pre-image to the receiver. The receiver can then submit a UZT. The validity under Geeq’s protocol is determined and then both the UZT and a Confirmation of Close LAR Transaction (CZT) are added to the next block to appended to the chain. Validity only requires that the UZT has the correct release pre-image and that it is submitted after the hold starts (but before it expires if there is an expiry time associated with the token). At the same time a Lockable Bearer Token Account Record (LAR) is zeroed out or removed from the chain’s CLS, and the value represented by the token is added to the account designated in the UHT.

In accordance with an embodiment, as with standard bearer tokens, similar schemes both on and off blockchains in which value is locked to a secret provided by the creator and that the creator has a second secret he can provide to any agent that allows the agent to temporarily convert the lockable bearer token to a certified token payable only to a public key or account he provides. Transactions fees could be collected at one or several points in this process.

The following describes an example of this process using Geeq’s specific implementation of lockable bearer tokens, in accordance with an embodiment for sender Alice and receiver Bob. Alice has an account on an instance of a GeeqChain containing coins (GEEQs). Alice creates a ULT that includes her account number, the value to be attached to the lockable bearer token, two hash digests of secrets known only to Alice, a private key signature authorizing the transfer of funds out of her account and onto the lockable bearer token. In another example, Alice receives and uses the hash digests from Bob. Thus only Bob knows the secrets.

Alice sends the ULT to a node on the chain where she has coins. If the ULT is valid under the chain’s protocol rules, the validation network approves the transaction and records this fact in the next block of the chain. Under Geeq’s protocol this requires including both the ULT and a CLT. The validation network also updates the CLS to include a corresponding LAR.

Continuing then, to use the lockable bearer token, Alice sends Bob a pre-image of the holding secret used to create the token. Bob creates a UHT transaction that includes the pre-image and his public key (or an account number derived from his public key). Like bearer tokens, this does not require an authorizing signature or that Bob have a preexisting account on the GeeqChain instance. If the UHT is valid under the chain’s protocol rules, the validation network approves the transaction and records this fact in the next block of the chain. Under Geeq’s protocol this requires including both the UHT and a CHT. This makes the certified token releasable only to the public key address included in the UHT.

Once Bob is satisfied that the hold is confirmed on the chain, he requests the “release” pre-image from Alice. Once this is received, he can provide streaming or other services to Alice secure in the knowledge that no one will be able to release the tokens to any account but his before he has a chance to submit his own release request to the chain. In an embodiment, Alice sends both secrets to Bob at the same time and Bob uses the holding secret to lock the lockable bearer token.

Bob creates a UZT transaction that includes the “release” pre-image. Like plain bearer tokens described previously, this does not require an authorizing signature or that Bob has a preexisting account on the GeeqChain instance.

If the UZT is valid under the chain’s protocol rules, and the UZT arrives before the hold-interval has elapsed, the validation network approves the transaction and records this fact in the next block of the chain. Under Geeq’s protocol this requires including both the UZT and a CZT.

The validation network also updates the CLS by: 1) Removing Alice’s LAR; 2) Adding the value in the LAR, less transaction fees, if any, to the Token Account Record (TAR) with the address corresponding to the public key which was included in the UHT transaction Bob submitted; and, 3) If the designated receiving address does not have a TAR on the chain, a new TAR is created and the token’s value is added.

In accordance with the foregoing embodiment, the following is noted. As for other bearer tokens above no smart contract is needed to create the LAR, and Bob does not need an account on the blockchain before he attempts to cash or consume Alice’s LAR. In accordance with the foregoing embodiment, Bob does not need to provide Alice with his public key to create the LAR. To cash the LAR, Alice first provides Bob with the holding pre-image, and then with the release pre-image. As with bearer tokens, lockable bearer tokens could be created and cashed in a variety of physical and virtual ways.

In accordance with an embodiment, LBTs include, either structurally or optionally, the condition if a LBT is ever held, but not closed, then it reverts to the creating account after the hold expires. Should another know and use the holding secret, they could hold it so that it could not be cashed by whomever was subsequently given the holding secret. In general, it would not be secure to give the holding secret out more than once, and the closing secret should be supplied whenever the holding secret is given. In an embodiment, LBTs are lockable more than one time. In an embodiment, a transaction configuration enables a changing of the hold secret for example, providing a current hold secret to remove a current hash digest and a new hold secret hash digest associated with a new hold secret to replace the hash digest in the LBT record. Thus, in accordance with embodiments, LBTs need not be constrained to only one holding, or may be provisioned with more than one holding secret that are used successively.

Though generally described herein with reference to coin and amounts thereof, bearer token records (e.g. of any of the locked or lockable variations described) are useful with any crypto assets that has been recorded (e.g. validated correctly) on a blockchain, whether it is a cryptocurrency, tokenized asset, non-fungible token, document, contract, resource, rewards points, etc. Thus in an embodiment, a bearer token record is generated that transfers a crypto asset from a sending account to a bearer token record associated with a hash digest of a secret. The secret is associated such that presenting the secret to the blockchain completes the bearer token record to transfer the crypto asset to a receiving account. Thus where the terms “use” or “cash” the bearer token or bearer token record is recited herein in a cryptocurrency asset scenario, the term “complete” is also employed in the context of a bearer token or bearer token record where the secret is provided and the transfer is completed to a receiving account.

In an embodiment, crypto-assets of various types live on a separate application layer of the blockchain in Geeq’s implementation. In other blockchains, such assets are created and controlled by smart contracts. In an embodiment, in the case of Geeq for example, an application layer token (such as an ERC20-type token, for example) a non-fungible token that represents ownership of a car or house, or even a fungible token representing partial ownership of off-chain assets like stocks, is transferred as follows: First an application layer transaction (which is wrapped in a validation layer transaction) to create a crypto-asset BAR is sent to a node. This creates a BAR on the application layer blockchain which is coded to a hash digest and is structured and used exactly like purely GEEQ coin BARs. Second, to release the app-layer BAR all that would be needed would be the pre-image. Third, fees could be prepaid when the app layer BAR (or other type of bearer token) was created, or paid by a validation layer BAR that is included in the app layer release transaction.

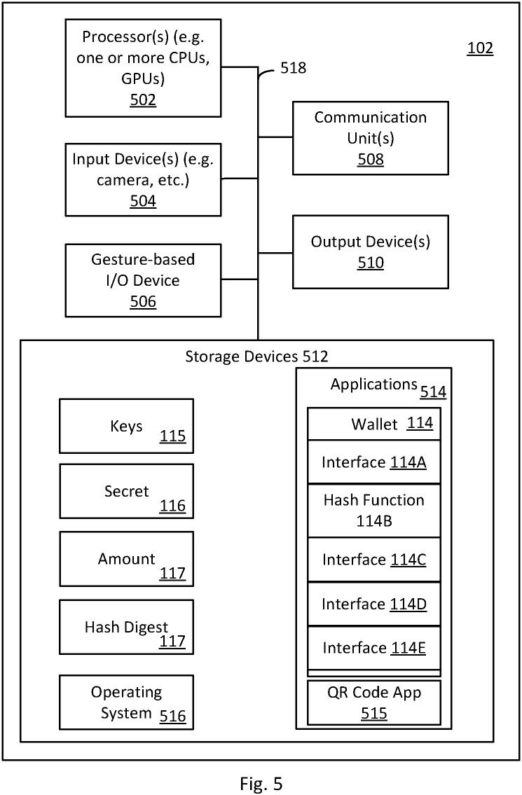

FIG. 5 is a block diagram of computing device 102, in accordance with one or more aspects of the present disclosure. Computing device 102 comprises one or more processors 502, one or more input devices 504, a gesture-based I/O device 506, one or more communication units 508 and one or more output devices 510. Computing device 102 also includes one or more storage devices 512 storing one or more modules and/or data. In an embodiment, modules include applications 514 including wallet application 114 and interfaces 114A, 114C, 114D and 114D and hash function 114B as previously described. Data includes keys 115, secret 116, amount 117, and release hash 118 as described. Wallet application 114 provides the functionality to perform transactions with transaction network 108 as described.

Storage device(s) 512 may store additional modules such as a QR Code App. to generate QR Codes for displaying and/or communicating electronically to another device such as device 110 or a printer (not shown). A module includes an operating system 516. Other modules (not shown) include communication modules; graphics processing modules (e.g. for a GPU of processors 502); map module; contacts module; calendar module; photos/gallery module; photo (image/media) editor; media player and/or streaming module; social media applications; browser module; etc. Storage devices may be referenced as storage units herein.

Communication channels 518 may couple each of the components 502, 504, 506, 508, 510, 512, and any modules for inter-component communications, whether communicatively, physically and/or operatively. In some examples, communication channels 518 may include a system bus, a network connection, an inter-process communication data structure, or any other method for communicating data.

The one or more processors 502 may implement functionality and/or execute instructions within computing device 102. For example, processors 502 may be configured to receive instructions and/or data from storage devices 512 to execute the functionality of the modules shown in FIG. 5, among others (e.g. operating system, applications, etc.) Computing device 102 may store data/information to storage devices 512. Some of the functionality is described further herein below. It is understood that operations may not fall exactly within the modules 114, etc. of FIG. 5 such that one module may assist with the functionality of another.

Computer program code for carrying out operations may be written in any combination of one or more programming languages, e.g., an object oriented programming language such as Java, Smalltalk, C++ or the like, or a conventional procedural programming language, such as the “C” programming language or similar programming languages.

Computing device 102 may generate output for display on a screen of gesture-based I/O device 506 or in some examples, for display by a projector, monitor or other display device. It will be understood that gesture-based I/O device 506 may be configured using a variety of technologies (e.g. in relation to input capabilities: resistive touchscreen, a surface acoustic wave touchscreen, a capacitive touchscreen, a projective capacitance touchscreen, a pressure-sensitive screen, an acoustic pulse recognition touchscreen, or another presence-sensitive screen technology; and in relation to output capabilities: a liquid crystal display (LCD), light emitting diode (LED) display, organic light-emitting diode (OLED) display, dot matrix display, e-ink, or similar monochrome or color display).

In the examples described herein, gesture-based I/O device 506 includes a touchscreen device capable of receiving as input tactile interaction or gestures from a user interacting with the touchscreen. Such gestures may include tap gestures, dragging or swiping gestures, flicking gestures, pausing gestures (e.g. where a user touches a same location of the screen for at least a threshold period of time) where the user touches or points to one or more locations of gesture-based I/O device 506. Gesture-based I/O device 506 and may also include non-tap gestures. Gesture-based I/O device 506 may output or display information, such as graphical user interface, to a user. The gesture-based I/O device 506 may present various applications, functions and capabilities of the computing device 102 including, for example, wallet application 114, QR Code App. as well as any messaging applications, telephone communications, contact and calendar applications, Web browsing applications, game applications, e-book applications and financial, payment and other applications or functions among others.

Although the present disclosure illustrates and discusses a gesture-based I/O device 506 primarily in the form of a display screen device with I/O capabilities (e.g. touchscreen), other examples of gesture-based I/O devices may be utilized which may detect movement and which may not comprise a screen per se. In such a case, computing device 102 includes a display screen or is coupled to a display apparatus to present secrets and GUIs of application 114 among others. Computing device 102 may receive gesture-based input from a track pad/touch pad, one or more cameras, or another presence or gesture sensitive input device, where presence means presence aspects of a user including for example motion of all or part of the user.

One or more communication units 508 may communicate with external devices (e.g. transaction network 108 and second computing device 110) such as for the purposes as described and / or for other purposes (e.g. printing) such as via communications network 106 by transmitting and/or receiving network signals on the one or more networks. The communication units may include various antennae and/or network interface cards, chips (e.g. Global Positioning Satellite (GPS)), etc. for wireless and/or wired communications.

Input devices 504 and output devices 510 may include any of one or more buttons, switches, pointing devices, cameras, a keyboard, a microphone, one or more sensors (e.g. biometric, etc.), a speaker, a bell, one or more lights, a haptic (vibrating) device, etc. One or more of same may be coupled via a universal serial bus (USB) or other communication channel (e.g. 518). A camera (an input device 504) may be front-oriented (i.e. on a same side as) to permit a user to capture image(s) using the camera while looking at the gesture based I/O device 506. A camera may capture a secret such as text or image data.

The one or more storage devices 512 may take different forms and/or configurations, for example, as short-term memory or long-term memory. Storage devices 512 may be configured for short-term storage of information as volatile memory, which does not retain stored contents when power is removed. Volatile memory examples include random access memory (RAM), dynamic random access memory (DRAM), static random access memory (SRAM), etc. Storage devices 512, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

In an embodiment, other user oriented computing devices (e.g. 110 and 416) are similarly configured as computing device 102.

Though not shown in detail, nodes of network 108 are computing devices similar in basic construction (processors, storage devices, communication devices, input and output devices) to computing device 102 but as server-side or server like devices. That is, nodes are often are not configured with consumer oriented hardware, having fewer input and output devices, fewer user applications, a server oriented O/S, and powerful processing, storage and internal and external communications components etc.

### Methods of Use

In accordance with embodiments, bearer and certified tokens allow for secure micro- and macro-payments. In accordance with embodiments, such payments may be transacted with minimized direct knowledge of, or connection to, a blockchain or other provider or intermediary. This section outlines several methods etc., in accordance with embodiments, for using or improving the utility of bearer and certified tokens.

### Expiration and Reversion

One problem with gift cards, prepaid credit and debit cards, vouchers, and coupons is that they often go partially or completely unused. This may be because they get lost, the owner forgets about them, or never has a good opportunity to consume them. In turn, this lowers their value and utility to consumers and makes them reluctant to purchase them. It also imposes the burden of keeping track of and remembering to use them.

In accordance with embodiments, bearer and certified tokens allow for an easy solution to this problem. All three types of tokens could include an expiry time (e.g. relative to a block in the block chain) as part of the data in the associated records and transactions. A bearer token created as a BAR in block N of a blockchain could be set to expire and revert in block N+100,000. As an example, if a blockchain commits new blocks every ten seconds, the bearer token would automatically expire and revert approximately twelve days after its creation.

In an embodiment, a method for a sender (payor) device comprises: generating or otherwise obtaining a secret; communicating a transaction to generate a bearer token (which may be a certified token) associated with the secret and an expiry time and an amount. The method further includes generating a bearer token representation, in electronic or physical form, comprising the secret and providing the bearer token representation as one of a gift card, prepaid credit card or debit card, voucher, and coupon or the like to facilitate cashing of the bearer token. In an embodiment the bearer token representation comprises any of text and image data presenting bearer token data to facilitate cashing of the bearer token. In an embodiment, such as for a gift card or other physical embodiment of the token printed, etc., on a substrate, the secret is hidden from view such as for later revealing. A coating may be applied over the secret, but other ways to hide the secret are also possible. The gift card, etc. may be sealed in an envelope or otherwise so that the secret is not visible on an outside surface thereof.

In an embodiment, the method is performed in association with a purchase/sale of the bearer token (e.g. as a gift card, prepaid card, voucher, etc.) including receipt of a payment such as a fiat currency payment, credit card payment, debit payment, etc. In an embodiment, the payment is a same amount as the amount of the bearer token (e.g. a fiat currency equivalent). In an embodiment, the payment includes a service charge (or transaction fee) in addition to the amount of the bearer token (e.g. a fiat currency equivalent). In an embodiment, the bearer token representation comprises the amount.

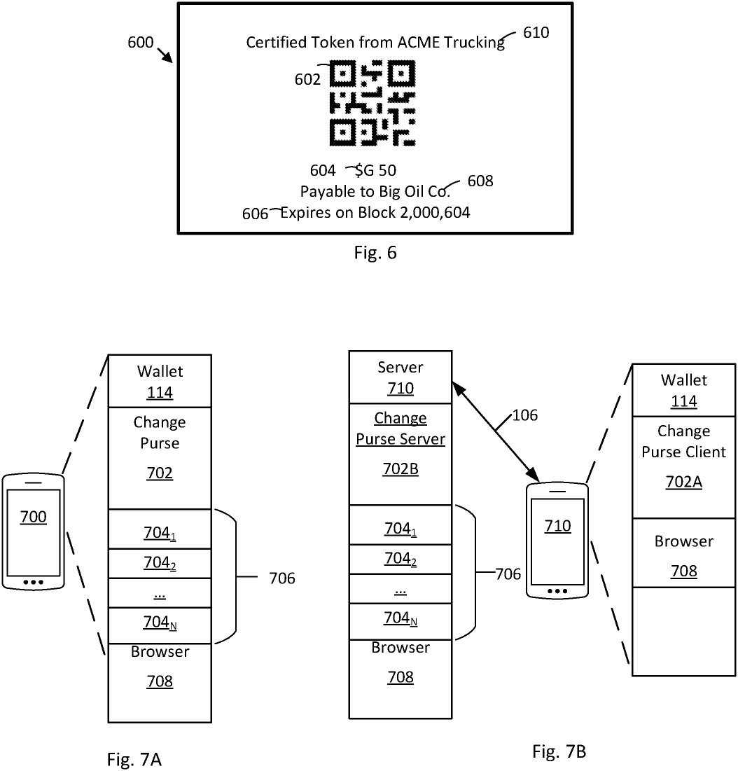

If the bearer token is certified token, the token further includes a receiving account (provided as transaction data for example). The receiving account is for a receiver entity such as a retailer (online or not), service provider (online or not), or any other entity to which a payment may be made (online or not). In an embodiment, the bearer token representation comprises information about the receiver entity. FIG. 6 is an illustration of an example of a bearer token representation 600 comprising a secret 602 as an encoded image (QR Code), amount 604, expiry information 606 and receiver information 608. Also included is information about the sender (payor) 610.

When a token expires and reverts, the associated account record is removed from the CLS and the value it contains is returned to the account that created the token in the first place. In the case of Geeq, in accordance with an embodiment, this would be done by nodes creating Bearer and Certified Token Reversion Administrative Transactions (BRA) and including it directly in block N+100,000. No user transaction is required, nor is any cryptographic signature for authorization. In accordance with an embodiment, Geeq’s protocol is configured to allow and require funds in BARs, CARs, and LARs, to be returned (less any transaction fees) to the account that created them at the expiration block contained in the account record.

As mentioned above, in accordance with an embodiment, original issuers of these tokens are financial or other institutions and enterprises. In these non-blockchain cases, funds in tokens would revert to the accounts that funded their creation or be held in trust for the agent that created them to reclaim after a specified expiration date.

### Low Security, High Accessibility Wallets

Public-private key pairs are mathematically entangled numbers that have the property that anything encrypted with one of the keys can only be decrypted with the other. Cryptocurrencies and blockchains generally use account numbers derived from a user’s public key. Access to the account is controlled by cryptographic signatures created with the corresponding private key. A private key is therefore kept secret since anyone who has knowledge of the private key has full access to the account connected the corresponding public key. If the private key is lost, then the user loses all control over the account. In fact, control of the account is permanently lost, and no agent will ever be able to access it again.

Because of this, private keys are kept secure so that they cannot be stolen by unauthorized parties. Simply keeping a file that lists the private keys on a computer or in the cloud subjects them to the risk of being hacked or exposed though social attacks or poor user security choices. There are a variety of hardware and software wallet solutions such as Trezor™ (a hardware wallet from SatoshiLabs s.r.o) and MetaMask™ (is a trademark of A. J. Davis, an individual) that purport to offer secure key storage, access, and recovery. Cryptocurrency exchanges and others offer custodial solutions where tokens are transferred out of user accounts and are held in exchange public key accounts on their native blockchains. Users are given access to their balances through passwords but do not directly hold keys.

Using custodial solutions requires that users trust in both the competence and integrity of the exchange or institution. Unfortunately, many exchanges have been hacked and billions of dollars of customer tokens have been lost. Wallet solutions are more secure and allow users to rely only on their own competence and caution. Unfortunately, this comes at the cost of usability. For many implementations, users must write down and keep secure 12 word seed phrases in order to recover lost private keys, remember pins (personal identification numbers) and passwords, and get wallets to connect and interact with various websites to transact on blockchains.

Bearer tokens, at root, are small text files and/or images encoding small amounts of text (e.g. comprising respective secrets for hashing as release or hold hashed digests) that are meant to convey small amounts of value. A user might create 500 crypto-pennies in the form of bearer tokens. While it is true that anyone who gained access to the file containing all the release pre-images could steal these pennies, the loss to the user would only be $5 (e.g. 5 crypto dollars).

As noted, each token has a different secret. In an embodiment, random numbers are generated as secrets such as by a wallet, which wallet keeps track of the secrets and sends them out to whomever the user wants to give them to. In practice, in an embodiment, a sender tells the receiver the secret and applicable additional blockchain data such as a chain number the BAR was on, the amount in the BAR, and the expiry date to make it easier for receiver to check the token and create a CXR.

In an embodiment, as BTs, CTs and LBTs are like cash, the entire amount is transferred when the BT (or CT or LBT) is cashed.

With reference to FIG. 7A, in an embodiment, there is proposed a computing device 700 providing an application defining a type of crypto change purse 702 or token store for a plurality (e.g. N) of bearer tokens. Computing device 700 is similar to device 102 and capable of communication with other devices such as in network system 100.

Once the bearer tokens are created on the blockchain (e.g. of network 108), bearer token files 704₁, 704₂, ... 704_{N} including their release secrets are stored in a directory 706 or other data structure of the change purse 702. In an embodiment, this directory is completely open, unencrypted, and unsecured on a user’s computer, mobile, or other device. In an embodiment, this directory is encrypted, password or otherwise protected. The directory is decrypted or opened at the beginning of a session or as needed by the user (e.g. using a PIN, password, gesture, biometric data input etc.).

In an embodiment, this directory is accessible to a browser 708 (or browser addon or plugin), or through an application (not shown) on device 700. This directly could be accessible to the user who authenticates to the device or system or require separate authentication. In an embodiment of computing device 710 of FIG. 7B, this directory 706 is in a cloud storage solution (e.g. provided by server 712) accessible by one of the methods described above (which in an embodiment includes client side change purse app. 702A and change purse server app. 702B).

In an embodiment, bearer tokens are created in small denominations in advance of use and then consumed relatively quickly (e.g. within weeks or a month). Thus, in such an embodiment, relatively small amounts of value are stored in these relatively less secure wallets. This reflects established use patterns for fiat currencies. People typically carry around small amounts of cash for small needs which they periodically replenish from more secure sources such as ATMs and bank accounts. Cash can always be lost or stolen, however, the convenience of cash makes the increased risk worthwhile for relatively small amounts of value.

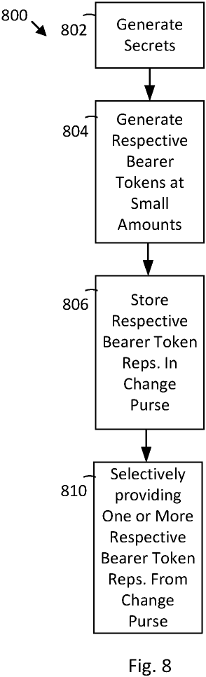

With reference to FIG. 8 showing a flowchart of operations 800, in an embodiment, a method for a computing device comprises generating a plurality of secrets 802; generating a plurality of bearer tokens (via UBTs) in small denominations (e.g. any of less than or equal to $50, less than or equal to 20 \$, less than or equal to 10 \$, less than or equal to $1, or less than or equal to $0.50) (at 804). Storing in a change purse respective electronic bearer token representations for each of the plurality of bearer tokens generated, each representation comprising a respective secret for use to cash a respective bearer token associated with the secret (at 806). Selectively providing one or more of the plurality of electronic bearer token representations to satisfy payment (e.g. for a product and/or service). In an embodiment, the storing is unsecure. In an embodiment, the storing is performed with a storage service located remotely to a local computing device enabled to provide the bearer tokens. In an embodiment, tokens are removed from the change purse when used (not shown).

In an embodiment, high accessibility wallets are configurable to hold standard private keys that would allow any sort of transaction on a blockchain in addition to bearer token. A recommended use case, in an embodiment, is to keep only small amounts of cryptocoins or other crypto-assets in these accounts, replenishing their balances as needed from more securely held accounts. A highly secure private key is typically stored in a manner that is not highly accessible, providing a measure of security such as by keeping the key away from electronic access, keeping the private key encrypted using another key, etc. Often such keys are stored in a way that keeps them decoupled from an accessible communication device to prevent access (e.g. by hacking or other means). Some examples include a USB token, a smart card, a hardware storage module (HSM). These devices are temporarily coupled to a device (having a wallet function) such as for a time when a transaction is signed and then removed from coupling.

In the method embodiment 800, an embodiment thereof comprises transferring an amount of cryptocurrency from a highly secure account (e.g. an account associated with a private key that is stored in a highly secure manner) to an private key account stored in the high accessibility wallets which is used for generating bearer tokens, also stored in the with the high accessibility wallet. The private key account stored in the high accessibility wallets is replenished by transferring performed using a private key maintained by a highly secure wallet and wherein the generating of the plurality of bearer tokens is performed using a high accessibility wallet.

### UI/UX Approaches

In accordance with embodiments, High Accessibility Wallets (HAW) and bearer tokens facilitate ways to use cryptocurrencies and blockchains. Wallet 114 in computing device 702 and 710 comprises a HAW.

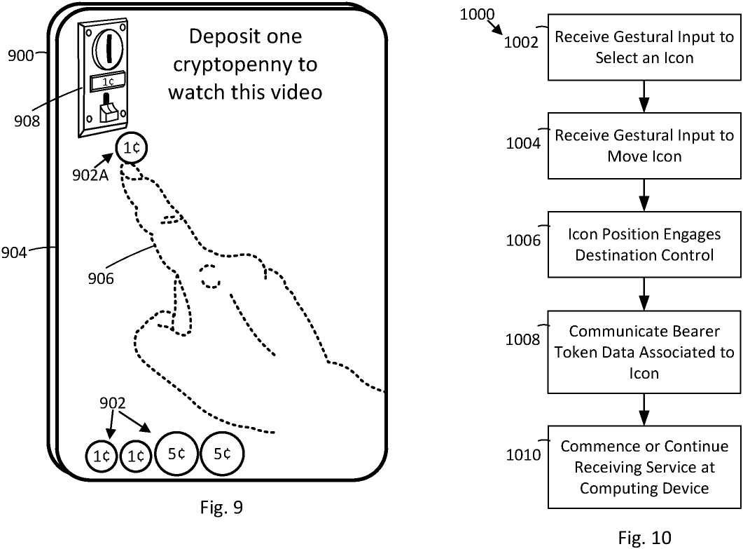

Swiping or tossing pennies: FIG. 9 is an illustration of a computing device 900 and FIG. 10 of operations 1000 of the computing device 900 in accordance with an embodiment. The device 900 is similarly configured to device 702 or 710, for example, having a change purse and a HAW. Computing device 900 is also capable of communication with other devices such as in network system 100. Device 900 may communicate with server device 130 such as to receive a service and to make payment therefor.

Device 900 displays an image or images 902 representing bearer tokens held in the HAW (e.g. in the change purse, a store of the device or accessible to the device). In an embodiment the images show respective associated denominations (e.g. 1¢ or 5¢). The image or images 902 are similar to icons having associated token controls (e.g. to receive gestural input to invoke the token control. In an embodiment, the gestural input selects and moves the icons (e.g. a drag gesture) over the display device 904).

In an embodiment, a graphical user interface component receives gestural input (at 1002) via a pointing device 906 such as a mouse, stylus or a finger (shown) interacting with the display device 904 to select a one (e.g. 902A, as shown) or more (not shown) icons invoking the token control at least in part. The interface is updated when a control is invoked (e.g. the icon may change and may be moved). Further gestural input is received at 1004 to move the one 902A icon to a payment window or coin drop 908 (at 1006) where the position of the icon engages the position of the window or coin drop 908 in the interface. The window or coin drop represents a destination region on the interface and may be associated with a destination control of the GUI. The interface (e.g. via the token control or destination control) detects when the gestural input drops the icon at the destination region. In the example, the icons represent a payment source and the window or coin drop a payment destination. In the embodiment, the GUI is provided as a Web page of a receiver entity (e.g. a on-line service provider or other vendor) such as an entity responsible for server device 130. In an embodiment, the GUI is provided as a component of an application, which application interacts with server device 130.

In an embodiment, at 1008, when the icon 902A is dropped at the destination region, the interface is configured to provide (e.g. communicate) the bearer token (e.g. the secret) associated with icon 902A to facilitate cashing the bearer token. In an embodiment, the interface is configured to communicate the data to the receiver entity (e.g. to server device 130) such as by using Web-based protocols). In an embodiment, tokens are removed from the change purse when used (not shown). That is, the bearer tokens are kept in a store (e.g. a file in a directory) and the store is updated in response to using the bearer tokens to cash bearer token records. The interface is also updated (not shown). For example, the respective token control of icon 902A is updated to present another of the bearer tokens (from the store) for cashing one of the bearer token records, which may have a different value requiring an icon update.

In an embodiment, the destination control is configured define a transaction to cash the token (e.g. a UXT) including a receiving account associated with the receiver entity and communicate the UXT to the transaction network.

In an embodiment, receipt and/or communication of the bearer token data by the destination control is configured to trigger the commencement or continuation of a service provided to the computing device (at 1010, the service is received at the computing device 900) such as an audio or video streaming service, game playing service, etc.

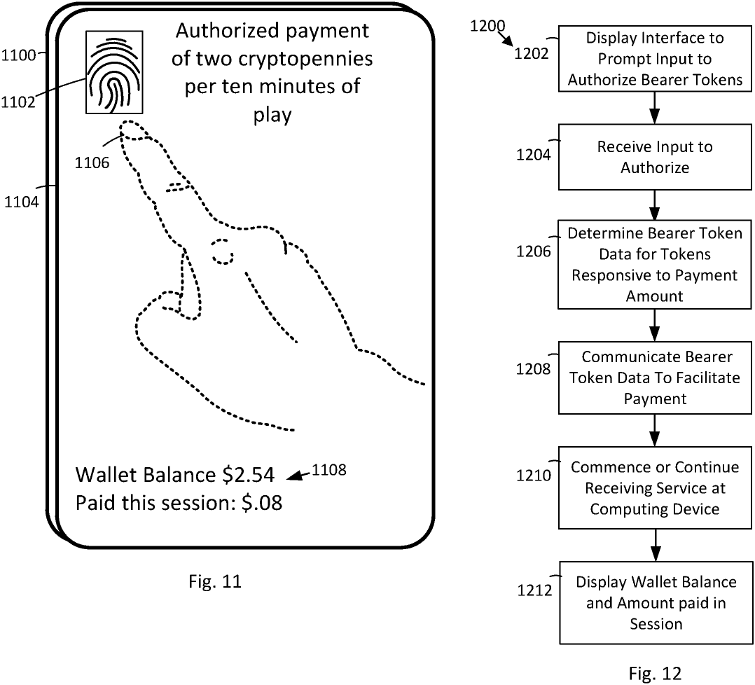

Authorization: FIG. 11 is an illustration of a computing device 1100 and FIG. 12 is an illustration of operations 1200 of the computing device 1100 in accordance with an embodiment. The device 1100 is similarly configured to device 702, 710 or 900, for example, having a change purse and a HAW and capable to communicate such as in network system 100 for a service from server device 130. In an embodiment, device 1100 stores bearer tokens accessible to the computing device, each of the bearer tokens associated to a respective one of a plurality of bearer token records associated with respective amounts of a cryptocurrency. The records and cryptocurrency re maintained on a transaction network (.g. 108) providing a blockchain. Each of the bearer tokens comprises a respective secret to be provided to cash the respective one of the bearer token records by the transaction network.

With reference to FIGS. 11 and 12, in accordance with an embodiment, a provider or vendor (e.g. a receiving entity associated with server device 130) requests payment through a Web page or app. A GUI component thereof on computing device 1100 (at 1202) displays an interface 1102 on display device 1104, for example, to prompt an input to authorize a use of one or more bearer tokens. The authorization initiates a communication (e.g. of at least some of the bearer tokens stored (the secrets) to a receiving entity) to facilitate use (e.g. cashing) of the bearer tokens. The communication makes a payment to the receiving entity. Via the GUI 1102, an authorization input is received (at 1204). The input may be any one of a password, PIN, gestural or biometric input. As depicted in FIG. 11, a user (via finger 1106) authenticates to the HAW app or plugin using GUI 1102. In an embodiment, GUI 1102 comprises a control to receive an input for an actual fingerprint (an example of a biometric input) or for a simulated fingerprint (an example of a sustained touch gesture where the gesture is held for a threshold amount of time) to facilitate a transfer of bearer token data from the change purse or other store of bear token data on or accessible to device 1100. In an embodiment, GUI 1102 prompts a fingerprint input via a hardware or software button or other input device facilitate a transfer of bearer token data from the change purse or other store of bear token data on or accessible to device 1100. In an embodiment, a biometric input comprises an iris input, a face feature input or a voiceprint input. In an embodiment a password or PIN input comprises an oral input, e.g. received via a microphone. In an embodiment, a gestural input comprises a touch and drag pattern over a gestural device such as a touch screen or a pad.

Though not illustrated an interface to receive an authorization input and a method of receiving an authorization input is provided, in an embodiment, to authorize generating a bearer token. For example, such an authorization may be performed in association with the operations 800 of FIG. 8, prior to step 802 or in association with the operations 300 of FIG. 3A, prior to step 302.

In accordance with an embodiment, a payment amount is specified to receive a service. In an embodiment the payment is a one-time payment requirement at a set amount. In an embodiment the payment is an on-going (e.g. periodic) payment requirement at a set amount (rate per time period). In an embodiment the payment is an on-going payment as long as services or content is being purchased and a regular stream of tokens are delivered to the provider. This embodiment is referred to as “streaming payments”.

At 1206 operations determine the payment amount and select bearer tokens from one or more tokens in the change purse or other storage responsive to the payment amount to be transferred. At 1208, operations communicate the bearer token data (e.g. sending the secrets via one or more communications) to a computing device of the receiving entity. In an embodiment, tokens are removed from the change purse when used.

In an embodiment, receipt and/or communication of the bearer token data to the computing device of the receiving entity is configured to trigger the commencement or continuation of a service provided to the computing device (at 1210) such as an audio or video streaming service, game playing service, etc.

In an embodiment, at 1212 operations display the wallet balance and the amount paid (1108) during the session. A session may be relative to a specific content (e.g. viewing or listening to a specific media item, of for general use of the app - while any content is streaming, game is playing, etc.

In an embodiment, the payment is a periodic payment requirement at a set amount each payment, for example, during a session. Authorization is sufficient to authorize on-going payments (e.g. while the app is active / during the session related to the specific content, etc.) Operations 1206 to 1212 are repeated to pay periodically through the session, receive the service and update the amount paid and the balance.

In an embodiment, the user can stop the streaming payments as desired. Payments are automatically stopped at the session end e.g. when streaming stops because it is completed or a user disconnects from the service, closes the app, etc.

Should the payment facilitated by the communication of the bearer token data not be completed – for example payment fails because the bearer tokens were previously cashed or for another reason – in sufficient tokens are stored in the change purse. The receiving entity may stop the service and/or terminate an account associated with the user. Termination for non-payment operations may be similarly performed in relation to the method of FIG. 10.

Streaming payments: A provider or vendor could request a certain payment per unit of time or increment of service. The user would authenticate to the HAW and approve a stream of successive token transfers to the provider until either the user or the provider discontinued the transfer. See too discussion related to FIG. 12.

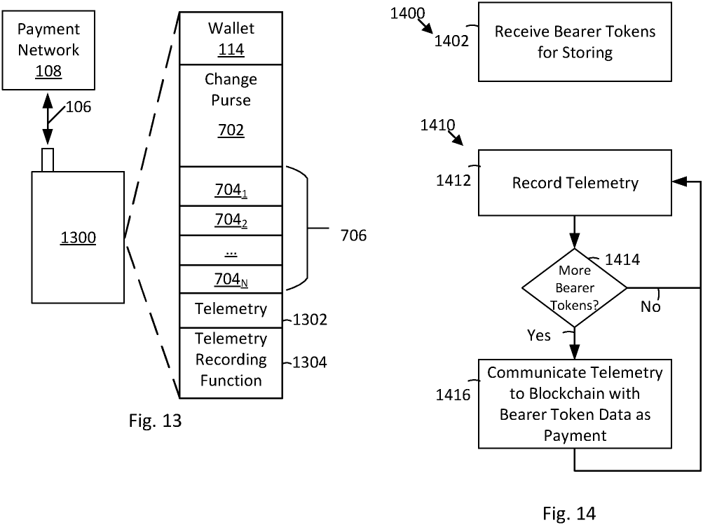

IoT payments: FIG. 13 is a block diagram of an internet of things (IoT) device in accordance with an embodiment, such as a burglar alarm, medical device, police body camera, or sensor configured to use a blockchain’s services to record telemetry 1302 (data) or send alerts using telemetry recording function 1304. IoT device 1300 is similarly configured as prior computing devices with a HAW 114 and a change purse 702 having tokens 704 in a store 706 and is capable of communication such as via network system 100. IoT devices typically include one or more sensor or data acquisition devices and may have fewer output devices (e.g. no or limited display screen) or other components to keep costs low. In an embodiment, an “IoT Wallet” is a variation of a HAW that has no keys to work with the blockchain and instead just provides a bearer token data store via the change purse.

Consider an example where, a fee is chargeable for the blockchain’s services. How is the fee paid? In one solution, a private key could be embedded in the IoT device’s firmware for use to authorize payments amounts that are periodically transferred from another account (e.g. a master account) to the IoT device’s account under control of its private key. This solution is unsecure, and if the IoT device were lost or taken out of service, the balances in its account could be lost if its private key is lost. In any event, the solution requires keeping track of the private keys of all IoT devices in some central store, which creates attack surfaces.

In accordance with a proposed embodiment, IoT device 1300, provisioned with bearer tokens in store 706, is configured to send to the blockchain (transaction network 108) bearer token data along with its service request. When the change purse 702 (with store 706) is exhausted of token data, in an embodiment, the store is replenished through a firmware update or other data push. This allows the IoT device to operate independently of any central server while the tokens hold out. If the device were lost or destroyed, the tokens would revert after some period of time and so would not be lost.

FIGS. 14A and 14B are flowcharts of operations 1400 and 1410 such as for IoT device 1300. At 1402, operations receive bearer token data for store 706. These may be received via firmware update, other data push. In an embodiment, bearer token data is received regularly to keep an IoT Wallet topped up.

At 1412 operations record telemetry. At 1414, a decision is made whether there are sufficient bearer token data to perform a transaction with transaction network 108 implementing the blockchain. If not, via the no branch, operations loop to 1412 to continue to record telemetry and continue looping until token data is received. If yes, operations proceed to 1416 where the telemetry (or an alert, for example triggered by the telemetry) is communicated with sufficient token data to facilitate payment for the transaction. Operations loop to 1412. Though not shown a decision responsive to the evaluation of telemetry may be performed before 1414 to determine whether a communication with the blockchain is indicated. The decision may relate to a sufficient collection of data or to another trigger determined by the telemetry evaluation (e.g. values changed or threshold met, etc.)

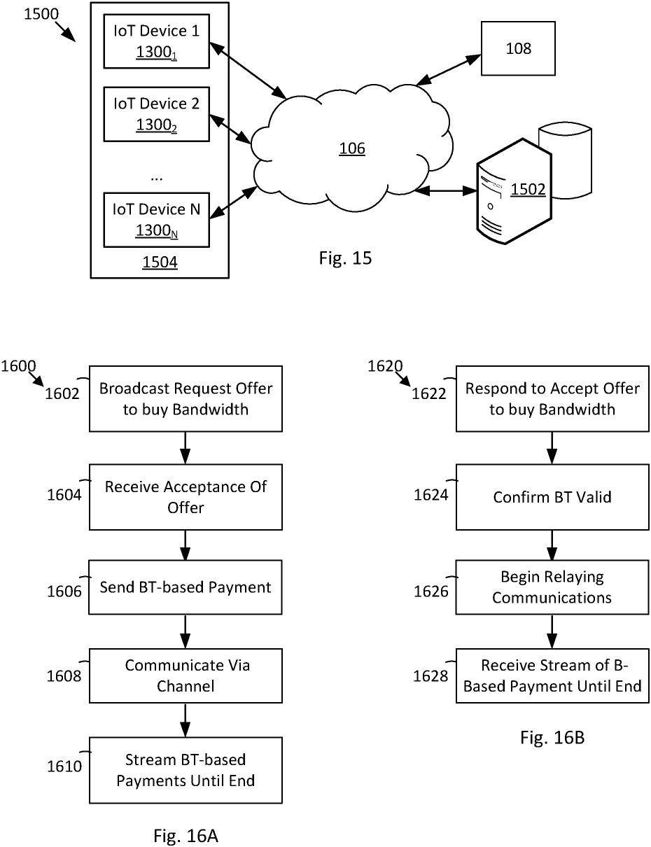

Iot devices could also use bearer tokens to facilitate machine to machine (“M2M”) markets of various kinds. FIG. 15 is an illustration of a network system 1500 comprising a plurality (N) of IoT devices, a server device 1502 and a transaction network 108 coupled for communication via network 106.

In an embodiment an IoT device comprises or monitors a connected electric meter (e.g. IoT Device N 1300_{N}). Such IoT Device 1300_{N} is configured to communicate with other IoT devices (e.g. IoT Device 1 1300₁. and IoT Device 2 1300₂) that comprise or monitor connected solar panels on houses (not shown) in the surrounding neighborhood. If the panels were producing surplus energy, the panels could feed surplus into a power grid (represented by box 1504) to which IoT Devices 1 1300₁ ... IoT Device N 1300_{N} are all connected. In an embodiment, the meter (i.e. IoT Device N 1300_{N}) uses this power. IoT Device N 1300_{N} makes a direct payment to the solar panels (and so to their owner) using BTs, for example, using a BT provisioned to it from server 1502. IoT Device N 1300_{N} shares the respective secrets for the BTs, which in an embodiment are CTs having the designated account for the owner of the solar panel.

Another example, also shown with FIG. 15, IoT Device 1300_{N} comprises a mobile device (e.g. a smartphone, tablet, automobile, laptop, etc.) IoT Device 1300_{N} is configured to make an electronic offer to buy Wi-Fi (a trademark of WI-FI Alliance) or PCS (Personal Communications Service), etc. connectivity from surrounding routers, cell phones, or cell towers (e.g. IoT Devices 1 1300₁ or IoT Device 2 1300₂, etc.) on a network (represented by block 1504) and on an ad hoc basis instead of through subscriptions. In an embodiment, a router with surplus bandwidth (e.g. IoT Device 2 1300₂) creates a hot-spot and allows IoT Device 1300_{N} to connect in exchange for a certain payment in BT per unit of time or unit of bandwidth.

FIGS. 16A and 16B are flowcharts of operations 1600 and 1620 respectively. At 1602 IoT Device 1300_{N} (a smartphone) broadcasts a request for connectivity via a channel (e.g. Wi-Fi, PCS, Bluetooth® (a trademark of Bluetooth Special Interest Group), etc.). At 1622, IoT Device 1300₂, which in the example is a router, cell tower, or other cellphone with available bandwidth responds and accepts an offer. Note there may be price or other term negotiation prior to acceptance (e.g. bandwidth or usage limitations (e.g. time or data limits) that are not shown.

At 1604, IoT Device 1300_{N} sends a bearer token in the required amount. At 1624 IoT Device 1300₂, confirms the token is valid (e.g. performs a look up (not shown)). At 1626 when the IoT Device 1300₂, is satisfied the token is valid, the provider begins accepting and relaying communications traffic back and forth between IoT Device 1300_{N} (at 1608) and IoT Device 1300₂′s connection to its provider. Cell phones will pass calls or data on to the local cell tower, while routers and cell towers generally will pass data through their established backhaul provider. At 1610 and 1628 BTs are streamed by IoT Device 1300_{N} to IoT Device 1300₂ until the connection is closed on either end.

In accordance with an embodiment, such M2M markets are managed automatically. In accordance with an embodiment, parameters and limits are set by a human user. BTs assure secure payment despite the relatively small value of the services being transacted.

CAR - Offline payments: If a user wished to buy an article such as a car, jewelry, art, or property such as a house, in an embodiment, the user creates a CT beforehand using a designated account (receiving account) data from the seller. The seller may be an individual conducting a private sale and have limited trust in the buyer.

The receiver (seller) is enabled to check in advance to make sure the CAR exists in the blockchain with the receiving account and then meets with buyer (sender). If the buyer and seller agree to transact, the buyer (sender) would simply handover the pre-image which could be checked offline. In an embodiment, the buyer provides a hash digest of the secret to the seller in advance to facilitate the seller to look-up the CAR on the blockchain to verify it exists with the correct amount and the seller’s designated account. In an embodiment, the seller uses the hash digest, e.g. via a wallet or other data look up interface, to review the blockchain’s data before going offline.

In an embodiment, the receiver (seller) would not need to check that the CAR still existed as the transaction is taking place since the previously verified CAR could only be closed using the pre-image and then only to the receiver’s (seller’s) benefit. At or during the transaction, the seller obtains the secret from the buyer (e.g. electronically via short range communication or in another manner such as a QR Code (buyer display device to seller’s camera)), uses a wallet-based or other hash function (of the same type that was used to record the CAR) to compute a hash digest of the secret for comparison with the hash digest earlier received from the buyer (e.g. and verified with the blockchain). Thus, secure transaction could take place without the need for real time connectivity.

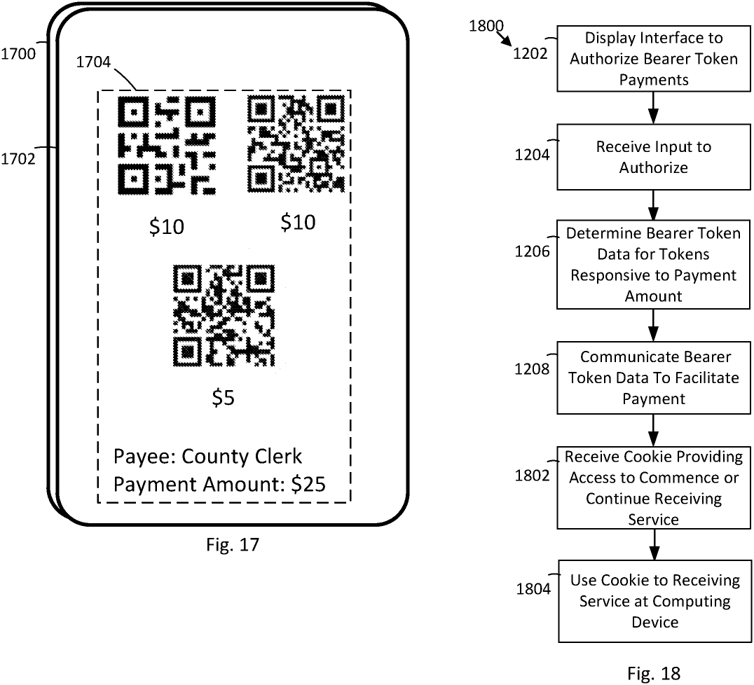

CAR - Dedicated petty cash: FIG. 17 is an illustration of a computing device 1700 having a display device 1702. In an embodiment, computing device 1700 is similarly configured to device 702 or 710, having a HAW and change purse or other store of bearer token data. In the embodiment, at least some of the bearer token data represents certified tokens. The HAW need not have a private key to generate bearer tokens via network 108.

By way of example, a law firm might file documents with a registry office on a regular basis or a trucking firm might need its drivers to be able to buy gas. Generally, a paying entity makes various payments frequently (by a staff or other member of the entity) to a same entity (A pays B regularly using a member of A). Giving employees cash or credit cards creates the possibility of fraud and requires significant accounting. In an embodiment, a paying entity creates certified tokens payable only to the registry office or the specific fuel provider. FIG. 17 illustrates an electronic form of bearer token representation 1704 to facilitate a payment. Bearer token representation 1704 comprises bearer token data for a certified token, including one or more secrets, associated amounts, a total and a receiver associated with a receiving account of the certified token. Though not shown, each certified token may have an expiry time.

As previously described FIG. 6 illustrates bearer token representation 600 in printed form on a physical substrate. In an embodiment, one or more employees are enabled to access bearer token representations 600 or 1500 like petty cash, but since the tokens are certified, payable only to the designated account of the receiver for purposes the paying entity intended, fraud is minimized. Accounting is also automatic on the blockchain. Finally, if too many tokens were purchased or some were lost by careless employees, the amounts in such tokens would revert and so their value would be recovered.

Micro-commerce and Micro-transactions: Users currently pay for ostensibly free internet searches and streaming content, social media services etc. with a micro-service in the form of looking at ads delivered by the respective platform. Another common way for platforms to fund their services is through subscriptions. Micro-services are feasible since no transactions fees need to be paid to collect them. Subscription are feasible only because the payment is high enough to offset payment network (e.g. credit card) and other transaction fees.

Bearer tokens open up a new category of commerce in which micropayments can be made with low transaction fees. This means that consumers can be given a third choice. Rather than being bombarded with ads or making a $10 subscription commitment per month to a provider, a consumer can transfer fractions of a cent at a time for either al la carte services or streaming services. In addition, digital and other items worth fractions of a dollar (or equivalent amount) (a virtual magic card, or a weapon in game) can be bought and sold since low transaction fees for bearer tokens make it feasible to transfer five or ten cents quickly and securely. An example of this type of micro-commerce would be for a provider to “sell a cookie” to a user for some small amount which would give them access to streaming or other services for specific period of time. FIG. 18 is a flowchart of operation 1800. Steps 1202, 1204, 1206 and 1208 are similar to those steps of operations 1200 at FIG. 12. At 1802, a computing device (e.g. device 1100) receives a cookie (a data file, not shown) providing access to commence or continue receiving a service (e.g. a streaming service, a digital thing like a card or weapon). At 1804 the cookie is used by device 900 to receive the service. The cookie may be provided to server device 130. Server device 130 may be configured such that the cookie provides a time limited benefit, for example, for a session, for a defined amount of time, etc.

Vouchers and scrip: Vouchers, tickets, coupons and scrip are a form of substitute for legal tender such as currency. Guests in resorts, amusement parks or on cruise ships could purchase certified tokens in varying amounts payable to the provider and keep them on a mobile device or as physical vouchers. They could then exchange them for services, rides, drinks, food, and so on. If they over-purchased, the balance would automatically revert to them when they go home. This gives an incentive to make a purchase while avoiding high transaction fees associated with credit cards and other payment providers. Certified tokens could also be created on an ad hoc basis as vouchers for specific goods and services. For example, a social service agency could give a client a certified token payable to a specific provider of shelter or medical services, or a charity could give someone in need a voucher good only for food, school books, or clothing from a specific vendor.

As an embodiment, a resort guest makes a fiat or crypto payment to the resort and have the guest’s HAW (or other suitably configured wallet) provide the resort with a number of hash digests and a list of amounts, quantities, and/or service types the guest wishes to have returned in form of BT crypto-asset vouchers (e.g. as confirmation of the creation of BT records). These are then stored on his mobile or other device associated to the respective secret as BTs. The guest might give these BTs to others, or reserve them for this own use. The guest would give the corresponding pre-images to the resort or its agents in exchange for goods and services. Any unused BT vouchers would revert to the creating account and their fiat or crypto value returned to the guest’s account. Alternatively, the guest could instruct his wallet to return the unused BT vouchers to the resort and have the resort refund them to credit his fiat or crypto account directly.

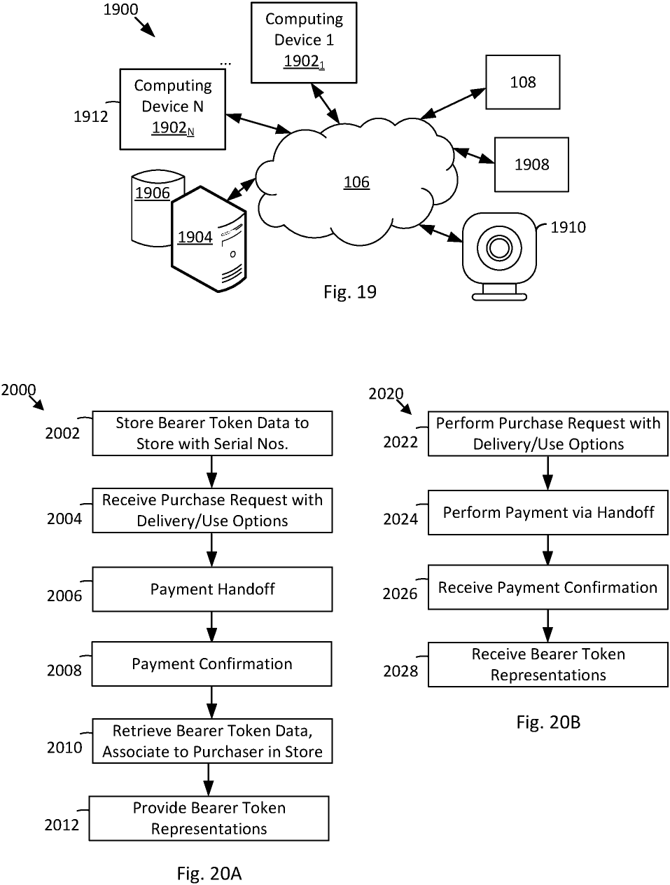

FIG. 19 is an illustration of a network system 1900, similar to network system 100 but simplified. Network 1900 shows a plurality (N) of computing devices 1902₁ to 1902_{N}, server device 1904, transaction network 108 (e.g. as a first payment network) and a second payment network 1908 and point of sale (POS) device 1910 communicating via network 106. In the embodiment, server device 1904 provides a service selling bearer tokens from its store 1906. Server device 1904 is configured as an e-commerce service, accepting payment such as by way of second payment network 1908. In an embodiment second payment network 1908 is a credit card payment network. In other embodiments it is a different on-line payment network. Though shown working with a single payment network, in an embodiment, server device 1908 works with and accepts payments from a plurality of transaction networks (not shown). Server device 1904 is representative of the devices used to implement the on-line service. Each of transaction networks 108 and 1908 comprise a plurality of devices to perform the respective functions.

Computing devices 1902₁ to 1902_{N} may take various form factors. In an embodiment one of the devices is a mobile device such as a smartphone, tablet or laptop. In an embodiment one of the devices is a desktop computer.

In an embodiment, one of the devices is configured as a kiosk such as a ticket kiosk capable of taking payment for providing (directly or indirectly) to transaction network 1908 and upon a successful payment transaction and responsive to server device 1904 providing a ticket, voucher, coupon, etc. comprising a bearer token representation from store 1906. Any of computing devices 1902₁ to 1902_{N} may be configured such as via a web-based interface to purchase one or more bearer token representations from store 1906. In an embodiment, bearer token representations are communicated electronically such as via email, text (short message service, instant message service, etc.) or download such as via a web browser. The received bearer token representations are printable or displayable such as on a display device of a computing device. The bearer token representations are sharable such as via communication or delivery of possession (handing a ticket to a person). In an embodiment the bearer tokens are certified bearer tokens such as for a ticket, voucher or coupon payable to a designated account. In an embodiment the certified bearer tokens have an expiry time.

POS device 1910 comprises a camera or other optical scanning device configured to receive data from a bearer token representation, whether from a printed substrate or a display device (screen of a mobile device). POS device 1910 captures a bearer token representation (or portions thereof such as barcode or QR Code) and communicates same to server device 1904. Server device 1904 is configured to generate transactions with transaction network 108 to cash the associated bearer token represented by the bearer token representation on the blockchain maintained by transaction network 108. In an embodiment, POS device 1910 is located in any of a hotel, convention center, resort, amusement park, cruise ship, casino, etc. and bearer token representations facilitate payment for a product or service such as food, beverages, a ride, game play or other amusement, etc.

FIGS. 20A and 20B are a flowcharts showing operations 2000 and 2020 of server device 1904 and a computing device (e.g. 1902_{N}) respectively to conduct a purchase/sale of bearer token representations in accordance with respective embodiments. It is understood that server device 1904 of another device on its behalf has previously generated bearer tokens (e.g. using operations 300 which may be amended for a certified token including a designated account and an expiry.) At 2002, server device 1904 stores respective records for generated bearer tokens in transaction network 108, including the respective secrets and a unique serial or tracking number for each. At 2004 server device 1904 receives a request to purchase a quantity of bearer token representations from computing device 1902_{N}. The request includes delivery and use options (e.g. electronic delivery and electronic use). At 2006 payment negotiation is handed off to second payment network 1908. At 2008, confirmation of payment is received. At 2010 responsive to confirmation of payment from second payment network 1908, server device 1904 retrieves bearer token representation data from its store 1906, associating same with purchaser (and payment method for any refund). The tokens’ records are flagged as sold.

In the embodiment, computing device 1902_{N} is a consumer user’ device. In accordance with an embodiment, server device 1904 receives a request that the bearer token representations are to be delivered and used electronically. If not stored as representations, representations are generated e.g. as a portable document format (PDF) or other format for use via a display. At 2012 the sold bearer token representations are provided. In an embodiment they are delivered via email. In an embodiment, the service has an associated user application 1912 loaded on device 1902_{N} and they are provided via push message to a store managed by the application. In an embodiment, the application manages use of the token representations, for example, receiving a notification following use at POS such as via POS device 1910. In such as case the tokens are removed from the store or the token representation data is obscured to an attempt at a further use.

With reference to FIG. 20B, operations 2022, 2024, 2026 and 2028 mirror many of the steps of operations 2000. At 2022, performing the purchase request may involve providing various user information, filling in or using an existing user profile, for example. At 2024 payment information is provided to second payment network 1908. Usual e-commerce processes may be used. E.g. a shopping cart etc. In an embodiment, a stored card (credit card data) may be used, etc. Payment confirmation is received (2026) and bearer token representations are received (2028). In embodiment, the transaction is performed via application 1912.

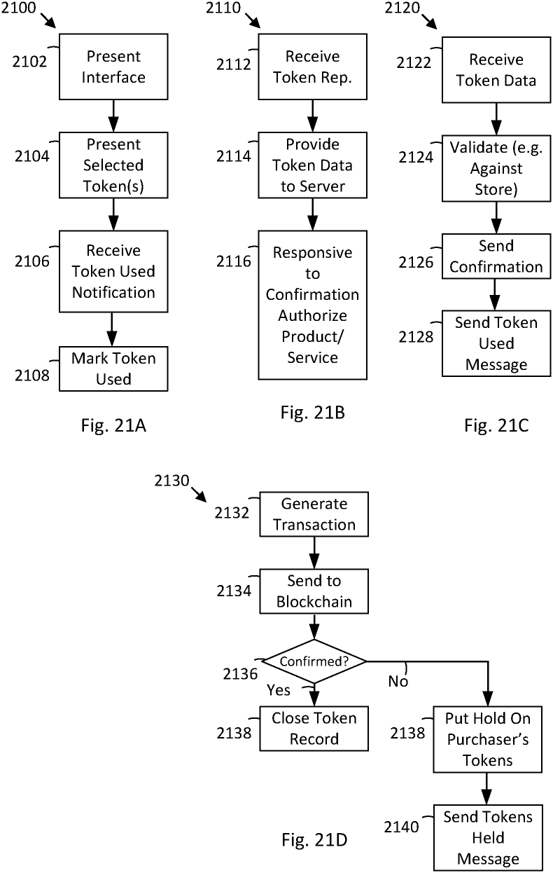

FIGS. 21A, 21B, 21C and 21D are flowcharts of respective operations 2100, 2110, 2120 and 2130 of computing device 1902_{N}, POS device 1910, and server device 1904 in accordance with respective embodiments. At 2102 computing device 1902_{N} using application 1912 provides a user interface to select from a store on the device one or more bearer token representations to facilitate a payment. At 2104 responsive to a selection, computing device 1902_{N} presents a bearer token representation via a display device to POS Device 1910 to facilitate the payment. At 2106 a notification is received indicating the token is used. At 2108 the token is flagged as used in the application 1912 to prevent further use (via the application, at least).

In an embodiment, the POS device 1910 is located at an amusement park and the user of device computing device 1902_{N} desires access to a ride (for themselves and/or another) or to purchase an item such as a food or beverage item or a souvenir, etc. At 2112 POS device 1910 receives token representation (e.g. optically). At 2114, token data is provided to server 1904. For example the data may be as captured or decoded by POS device 1910. At 2116, responsive to confirmation from service device 1904, the product or service is authorized. For example, POS may produce a message, etc.

In accordance with an embodiment, confirmation comprises an acknowledgment that the token data is received. No “real-time” check is performed by server device 1904 to validate the data. In accordance with an embodiment, confirmation comprises an acknowledgment that the token data is from a token data representation sold to the purchaser. A check of data in local store 1906 is performed. In accordance with an embodiment, confirmation comprises an acknowledgment that the bearer token remains uncashed, for example, as of a current or recent block number. To facilitate such a blockchain check. Server device 1904 (or another device) may periodically obtain bearer token data from transaction network 108 or another device providing a mirror of current data for use as a source for validation.

In accordance with an embodiment where local data service as a validation source, with reference to FIG. 21C, at 2122, server device 1902 receives token data. At 2124, the token data is validated against data in store 1906. The token record is flagged as used. At 2126, confirmation is sent to POS device 1910. At 2128 confirmation of the use of the token is sent to computing device 1902_{N} (e.g. for use by application 1912 (flagging bearer token rep. as used or removing it).

In accordance with an embodiment, with reference to FIG. 21D, at 2132 server device 1904 generates a transaction to cash a certified bearer token from the data received in payment in operations (e.g. from FIGS. 21A to 21C). At 2134 the transaction is sent to a node of transaction network 108 for processing on the blockchain. A processing time period of at least a few minutes is typically occasioned. A decision is made whether the transaction is confirmed (that cashing was successful). If yes, via branch to 2138, the token record in store 1906 is closed. If not, via branch to 2138, a hold is flagged on purchaser’s token records in store 1906. A message is sent to put a hold on the token representations in application 1912 (at device 1902_{N}). A dispute mechanism may be followed in case of a dispute and if resolved to the purchaser’s favor, the hold is lifted.

Though not shown, at expiry of the tokens, server device 1904 receives the token amount back to its sending account from which account the amount of the token was sourced. In an embodiment, server device 1904 reconciles expired tokens using its records. Server device 1904 provides a purchase refund to purchaser (e.g. using second payment network 1908).

It will be apparent to persons of skill in the art that bearer tokens (including a type thereof, namely certified tokens) advance the capabilities of blockchain technology to transfer and convey value in a decentralized manner. Bearer tokens may be useful for mass adoption of blockchain technology. A persistent barrier to adoption has been the level of difficulty in transferring cryptographic assets from one account to another. Bearer token and certified token technology simplify ways for a blockchain account holder to transfer value to a non-specific recipient or a pre-specified recipient, respectively. These categories of tokens have characteristics that are analogous to cash (bearer tokens) and certified checks (certified tokens) in traditionally intermediated financial markets.

In embodiments, bearer token technology primarily applies to cryptographic assets that exist on a blockchain, such as a cryptocurrency, non-fungible token, rewards points, etc. In embodiments, certified token technology may be further generalized to transfers of physical assets or shares that exist off-chain but are recorded on blockchain as tokenized assets, such as car titles, stocks, or other official documents.

It will be apparent to persons of skill in the art that, in respective embodiments, there is provided a wallet and/or change purse functionality to facilitate the use of these tokens, several applications enabled by these tokens such as micropayments, machine-to-machine payments, and streaming payments, as well as UI/UX that support these functions and uses. It will be apparent to persons of skill in the art that in embodiments, the technologies also include the ability to customize tokens with locks, expirations, and reversions to the original account if unused.

Thusly, it will be apparent to persons of skill in the art that, in accordance with embodiments herein, bearer tokens are a category of tokens that allow a blockchain account holder to create a token with pre-determined value. A bearer token enables the account holder to carry the representation of that token’s value freely, that is, detached from their blockchain account and the limitations and frustrations associated with cryptographic wallets. In this sense, bearer tokens are analogous to denominations of cash. Once a bearer token is created, it may be transferred to any recipient. The recipient may be a person or a machine. The recipient is not required to have a pre-existing account on a blockchain. The account holder may spontaneously convey the bearer token, peer to peer, via text, email, as a .pdf, as an exchange of paper or through any other simple arrangement for data transfer. Once created, the convenience of using a bearer token is that neither the creator nor the recipient has to protect, retrieve, or employ electronic keys while conveying the value of the bearer token. In fact, in some cases, a bearer token may be conveyed without any need for connectivity to the internet. Bearer tokens may be redeemed in any number of convenient ways, for example, through plugins or on mobile devices through apps. Bearer tokens, like cash, are not securely tied to an identity. Therefore, they are most likely to be created in small increments and/or small denominations. In embodiments bearer token technology facilitates blockchain use cases such as micropayments, machine-to-machine payments, streaming payments for content and other services, and automated payments.

Thusly, it will be apparent to persons of skill in the art that, in accordance with embodiments herein, certified tokens are a category of tokens that permit transfers of an asset of pre-determined value (e.g. units of coins) or type (the title to a specific car). A certified token is similar to its technology for a bearer token in the ways that it simplifies the transfer and conveyance of value. An important difference is that, at creation, a certified token designates the conveyance of the asset to an account associated with a specific public key. In this respect, certified token technology creates a cryptographic equivalent to a certified check or money order. While any person or machine who receives a certified token may redeem it, the value of the certified token will always go to the designated account. Certified tokens may be securely transferred peer-to-peer or through several intermediaries. For example, the creator may be a donor who is able to transfer a certified token to any intermediary, who then redeems it for the intended charity.

Thusly, it will be apparent to persons of skill in the art that, in accordance with embodiments herein, technology for bearer tokens and certified tokens simplify interactions that rely on accounts on blockchains. These technologies de-couple the requirements of timing and availability to the underlying blockchains with the means and methods of conveying cryptographic assets or tokenized assets. By increasing convenience, reducing technological burden, and widening the use cases for blockchain to include micropayments.

Thusly, it will be apparent to persons of skill in the art that, in accordance with embodiments herein, there are provide various aspects.

For example, there is provided a method comprising: receiving, at a transaction network, transaction data for a transaction to generate a bearer token record to transfer an asset; and generating the bearer token record; wherein the transaction data comprises: the asset; a sending account in the transaction network from where the asset is to be transferred; and a release hash digest computed from a release secret; and wherein to complete the bearer token record the release secret is used to match with the release hash digest to transfer the asset to a receiving account.

In an embodiment, the release secret is defined as any of text and an encoded image. In an embodiment, to generate the account comprises transferring the asset from the sending account to the bearer token record. In an embodiment, the transaction data comprises expiry data to determine an expiry time for associating with the bearer token record at which expiry time the asset reverts to the sending account if the bearer token record is yet to be completed using the release secret.

A type of the bearer token account (e.g. a (plain) BT, a CT or LBT) may drive the transaction data definitions. In an embodiment, the transfer is to be completed to the receiving account maintained by the transaction network. In an embodiment, the transaction data comprises no receiving account for completing the transfer, the receiving account later received or generated when the bearer token record is completed. In an embodiment, the bearer token record comprises a certified token record; and the transaction data further comprises the receiving account to which the asset is to be transferred for use to generate the certified token record. In an embodiment, the bearer token record comprises a lockable bearer token record; the transaction data further comprises a second hash digest computed from a holding secret for locking the lockable bearer token record to the receiver account, wherein to complete the locking requires providing to the transaction network the holding secret and account information for the receiving account so that only a single agent is enabled to complete the lockable bearer token record.

In an embodiment, the method is performed by a first node of the transaction network and wherein: the first node first receives the transaction data from a computing device outside the transaction network in communication with the first node; and the first node communicates the transaction data within the transaction network to facilitate processing of the transaction by other nodes maintaining a blockchain.

In an embodiment, the method comprises verifying a signing of the transaction data, the transaction data signed by a private key associated with the sending account.

In an embodiment, there is provided a method comprising: receiving, at a transaction network, transaction data for a transaction to use a bearer token record maintained by the transaction network, wherein: the bearer token is associated with: an asset to be transferred; and a release hash digest computed from a release secret; and the transaction data comprises the release secret; using the release secret to match to the release hash digest; and responsive to a match, transferring the asset. In an embodiment, the transaction data further comprises account information for a new account to define a receiving account where the asset is to be transferred; and the method comprises generating the receiving account and transferring the asset to the receiving account. In an embodiment, the transaction data further comprises account information to determine the receiving account maintained by the transaction network where the asset is to be transferred and wherein the asset is transferred to the receiving account.

In an embodiment, the bearer token record comprises a certified token record; and the certified token record is further associated with a receiving account to which the asset is to be transferred when the certified token record is completed; and transferring the asset transfers the asset to the receiving account associated with the certified token record. In an embodiment, the bearer token record comprises a lockable bearer token record; and the lockable bearer token record is further associated with a second hash digest computed from a holding secret for locking the lockable bearer token record to a receiving account; and the method comprises: receiving locking transaction data to lock the lockable bearer token record, the locking transaction data comprising the holding secret and account information for the receiving account; using the holding secret to match with the second hash digest; and responsive to a match, locking the lockable bearer token record to the receiving account so that only a single agent is enabled to complete the lockable bearer token record.

In an embodiment, the transaction data to complete the bearer token record is unsigned by a private key.

In an embodiment, the asset comprises an amount of a currency defined to satisfy a micro-transaction. In an embodiment, the transaction network stores transaction records including bearer token records in accordance with a blockchain consensus protocol. In an embodiment, the asset is a crypto asset comprising any one of cryptocurrency, tokenized asset, non-fungible token, document, contract, resource, and rewards points. In an embodiment, the asset is an amount of cryptocurrency maintained by the transaction network.

There is provided a computing device to facilitate blockchain coin transfers, the computing device comprising a processing unit coupled to a storage device storing instructions which when executed by the processing unit configure the computing device to provide: a transaction interface configured to: receive bearer token record generation transactions each comprising generation data to generate a respective bearer token record, each generation data respectively comprising an amount, sending account information and a hash digest of a release secret to transfer coin in a value specified by the amount from a respective sending account to the respective bearer token record; receive bearer token record cashing transactions each comprising cashing data to cash a respective one of the bearer token records, the cashing data comprising the release secret to match with the hash digest of the respective one of the bearer account records to transfer the amount of coin to the receiving account associated with the one of the respective bearer token records; and a transaction processor to process transactions using a blockchain consensus protocol, storing blockchain transaction data to blocks of a blockchain. Each release secret defines a respective bearer token for exchange off of the blockchain to facilitate a transfer of coin on the blockchain.

In an embodiment, the computing device is further configured to provide an interface to review blockchain transaction data to verify bearer token records. In an embodiment, the cashing data comprises account information for the receiving account.

In an embodiment, only the generation data is required to be signed. In an embodiment, each release secret comprises at least 32 bytes of data. In an embodiment, each release secret is defined as an encoded image.

In an embodiment, some of the bearer token record generation transactions generate respective bearer token records in association with a respective expiry at which the coin associated with the respective bearer token record is reverted to the sending account if not previously transferred by one of the cashing transactions.

In an embodiment, some of the bearer token record generation transactions are configured to generate the respective bearer token record with a lock to the receiving account at generation thereby to lock the transfer of the coin to a receiver associated with the receiving account.

In an embodiment, some of the bearer token record generation transactions configure the respective bearer token record to be subsequently lockable to the receiving account after generation thereby to subsequently lock the transfer of the coin to a receiver associated with the receiving account.

In an embodiment, the cashing data for a respective bearer token account further comprises account information for the receiving account. In an embodiment, the account information for the receiving account is used to generate a new coin account when the receiving account is not previously recorded to the blockchain.

In an embodiment, at least some of the respective bearer account records are associated to respective amounts of coin to facilitate payments of micro-transactions.

There is provided a method comprising: storing bearer tokens accessible to a computing device, each of the bearer tokens associated to a respective one of a plurality of bearer token records associated with respective amounts of a cryptocurrency, the records and cryptocurrency maintained on a transaction network providing a blockchain and each of the bearer tokens comprising a respective secret to be provided to cash the respective one of the bearer token records by the transaction network; and providing an interface comprising at least one respective token control, each respective token control linked to a respective one of at least some of the bearer tokens and each respective token control configured to receive an input to invoke the control to use the respective one of the bearer tokens to cash the associated bearer token record; receiving an input via the interface to invoke one respective token control and communicating the respective secret of the bearer token associated with the respective token control to facilitate payment via the transaction network.

In an embodiment, the input comprises a gestural input. In an embodiment, the gestural input drags and drops the one respective token control at a destination control.

In an embodiment, each respective token control comprises a respective icon representing a respective amount of cryptocurrency associated to the respective token control.

In an embodiment, the method comprises updating the interface in response to input invoking one respective token control. In an embodiment, updating comprises updating the at least one respective token control to present another of the bearer tokens for cashing one of the bearer token records.

In an embodiment, the bearer tokens are stored to a store and the store is updated in response to using the bearer tokens to cash bearer token records.

In an embodiment, the method comprises receiving a service in response to communicating the respective secret of the bearer token.

In an embodiment, the method is performed periodically e.g. to provide streaming payments, to continue receiving the service.

In an embodiment, the method comprises receiving a cookie for use to receive the service.

In an embodiment, there is provided a method comprising: storing bearer tokens accessible to a computing device, each of the bearer tokens associated to a respective one of a plurality of bearer token records associated with respective amounts of a cryptocurrency, the records and cryptocurrency maintained on a transaction network providing a blockchain and each of the bearer tokens comprising a respective secret to be provided to cash the respective one of the bearer token records by the transaction network; and providing an interface comprising an authorization input control to receive input to cash an amount of bearer token records to facilitate receiving a service; in response to receiving an authorization input via the authorization input control: providing at least some of the bearer tokens to facilitate cashing the bearer token records.

In an embodiment, the method comprises updating a store of the bearer tokens in response to the providing. In an embodiment, the interface displays a balance of bearer tokens accessible to the computing device.

In an embodiment, the interface displays an amount paid during a session of the service.

In an embodiment, the method further comprises, in response to receiving an authorization input: determining a payment amount to receive the service; selecting bearer tokens from a store of the bearer tokens to meet the payment amount and using the bearer tokens as selected to provide to facilitate the cashing. In an embodiment, the payment amount is an amount per time period and a single authorization input authorizes multiple payments (e.g. streaming payments) at the payment amount during a session of the service.

In an embodiment, the authorization input comprises any one of a password, PIN, gestural input or biometric input.

In an embodiment, there is provided a computing device to facilitate blockchain coin transfers, the computing device comprising a processing unit coupled to a storage device storing instructions which when executed by the processing unit configure the computing device to provide: access to a store of bearer tokens, each of the bearer tokens associated to a respective one of a plurality of bearer token records associated with respective amounts of a cryptocurrency, the records and cryptocurrency maintained on a transaction network providing a blockchain and each of the bearer tokens comprising a respective secret to be provided to cash the respective one of the bearer token records by the transaction network; and an interface to provide bearer tokens to facilitate a transfer.

In an embodiment, the interface to provide bearer tokens is configured to communicate bearer tokens to another computing device. In an embodiment, the interface to provide bearer tokens is configured to print bearer tokens.

In an embodiment, the interface to provide bearer tokens is configured to receive input to select between the bearer tokens in the store, the interface providing coin amount information for amounts associated with the bearer tokens.

In an embodiment, the computing device is configured to, in response to providing one of the bearer tokens from the store, update the store to remove the bearer token. In an embodiment, the computing is configured to receive bearer tokens and update the store in response to the receiving.

In an embodiment, the computing device is configured to provide a hash function to hash the respective secret of a bearer token and an interface to review respective bearer token records maintained on the blockchain to determine if the bearer token has been cashed. In an embodiment, the computing device is configured to limit access to the store of bearer tokens, the limit responsive to an authorization input comprising one of a password, a PIN, a gestural input and a biometric input. In an embodiment, the computing device is configured to communicate a bearer token to the transaction network to cash the bearer token.

Bearer tokens (e.g. the basic BT and its variants certified token and secure token) may be implemented in a variety of manners. Below is described an additional embodiment of bearer tokens and its variants. The bearer tokens and its variants may be used in any of the uses described hereinabove, for example.

The following tables provide various record types and field descriptions therefor for a bearer token implementation in accordance with an embodiment. The tables include: a bearer token account record (Table 6), an unverified bearer token transaction (Table 7), a revert bearer token administrative transaction (Table 8) and an allowed values for TransTypeBT (Table 9), namely a transaction type for a bearer token.

Tables 6-8 show field names, meaning of such data fields and a “Count”. Count is one of “SR”, “SD” and “MO” where the letters “S”, “M”, “R”, “D” and “O” mean, “single”, “multiple”, “required”, “optional” and “depends on type”, respectively.

TABLE 6

Bearer Token Account Record

| | | |
|---|---|---|
| Designator | Meaning | Count |
| BTAccRec_G | Bearer token account record | SR |
| BlkNum | ID number of record creation block | SR |
| RevBlk | The block number that a bearer token balance reverts | SR |
| TransTypeBT | Identifies the type of bearer token record | SR |
| HashDigestBT | Hash digest one (H₁) | SR |
| HashDigestBT | Hash digest two (H₂) | SD |
| AccNumRec | Receiving account number | SD |
| AmntBal | Balance in this bearer token | SR |
| AccNumSend | Sending account number | SR |

TABLE 7

Unverified Bearer Token Transaction

| | | |
|---|---|---|
| Designator | Meaning | Count |
| UnVerBTTrans_G | Unverified bearer token transaction | SR |
| BlkNum | ID number of the block target | SR |
| ChnNum | ID number of chain target | SR |
| NetActID | ID number of node target | SR |
| Nonce | Nonce of the funding account record | SD |
| TransTypeBT | Identifies the type of bearer token transaction | SR |
| RevBlk | ID number of bearer token reversion block | SD |
| HashDigestBT | Hash digest one (H₁) | SD |
| HashDigestBT | Hash digest two (H₂) | SD |
| HashPreImageBT | Hash pre-image (P₁) unlocks hash digest one (H₁) | SD |
| AccNumRec | Receiving Account Number | SD |
| AccNumSend | Sending Account Number | SD |
| PubKeyUser | Public Key - User (Sending Account) | SD |
| SigUser | Signature - User (Sending Account) | SD |

TABLE 8

Revert Bearer Token Administrative Transaction

| | | |
|---|---|---|
| Designator | Meaning | Count |
| RevBTAdTrans_G | Revert bearer token administrative transaction | SR |
| DataCount | The number of repeated network actor number/Fee payments that follow. May be zero. | SR |
| Hash | Hash of the bear token account being reverted in place of an account number | MO |
| AmntTrans | Geeq transaction amount | MO |
| AmntFee | Fee amount charged for the revert transaction. | MO |
| ... | ...HashAmntTrans/AmntFee triples repeat DataCount times... | ... |

TABLE 9

Allowed Values for TransTypeBT

| | |
|---|---|
| Value | Meaning |
| Create Bearer Token | Creates a new bearer token. Requires an existing user account, a lock hash, and a revert block. No receiving account is designated. |
| Consume Bearer Token | Consumes an existing bearer token in its entirety. Requires a correct pre-image, and a receiving account number. |
| Create Certified Token | Creates a new certified token. Requires an existing user account, a lock hash, a revert block, and a receiving account. |
| Consume Certified Token | Consumes an existing certified token in its entirety. Requires a correct pre-image. Paid only to predesignated receiving account number. |
| Create Secure Token | Creates a new (locked) secure token. Requires an existing user account, two lock hashes, and a revert block. No receiving account is designated. |
| Unlock Secure Token | Unlocks an existing secure token for transfer or consumption. Requires a correct pre-image of the first lock hash, and a new lock hash of the byte array (P₂ \| H₄ \| H₅ \| RevBlk \| AccNumSend ) if the intention is to transfer, or of (P₂ \| AccNumRec ) if the intention is to consume, where these elements are the second lock hash pre-image, two new lock hashes, a new revert block, a new sending account number, or a new receiving account number. This new lock hash replaces H₁ in the unlocked secure token record |
| Consume Secure Token | Consumes an existing unlocked secure token in its entirety. Requires a correct pre-image of the second lock hash (P₂ ) and the receiving account number. The last two are concatenated to form the pre-image of the new lock hash, H₁. The balance can be paid only to designated receiving account number. |
| Transfer Secure Token | Transfers an existing unlocked secure token in its entirety. Requires a P₂, H₄, H₅, BlkNum, and AccNumSend as used to unlock the secure token which was concatenated to check the new lock hash, H₁, while P₂ is used to check the second lock hash. Lock hashes, revert block, and sending account are updated, and the record becomes a new locked secure token. |

When creating a BT or one of its variants, such tokens are funded out of AccNumSend if PubKeyUser and SigUser are correct. The sending account is charged the transaction amount and transaction fee and a bearer token account record of the requested type is added to the ledger (e.g. in the blockchain). When creating a (basic) bearer token via a Create Bearer Token transaction, the bearer token creator includes H₁ in the create transaction which is a hash of P₁, known only to the creator. For a Consume Bearer Token transaction, the bearer token creator sends P₁ to a payee. The payee creates a (consume) bearer token transaction with P₁ and a receiving address. During processing of the consume transaction, if Hash(P₁) = H₁, then nodes transfer the balance, less fees, to the receiving account, and remove the bearer token record from the ledger.

For a Create Certified Token transaction (a bearer token variant), the certified token creator includes the receiving address of the intended payee, and H₁ in the create transaction. For a Consume Certified Token transaction, the certified token creator sends P₁ to a payee. The payee creates a consume transaction with P₁ (no receiving address is needed). During processing of the consume transaction, if Hash(P₁) = H₁, then nodes transfer the balance, less fees, to the receiving account provided by the creator and removes the certified token record from the ledger.

For a Create Secure Token transaction (a bearer token variant), the secure token creator includes two hashes, H₁ and H₂, in his create transaction instead of one, and keeps the pre-images, P₁ and P₂, secret. The secure token is locked when it is created and must be unlocked before it can be transacted. As described below, unlocking may be associated with further activities, for example, to consume and unlocked secure token or to transfer an unlocked secure token.

For a Unlock Secure Token transaction, the secure bearer token creator sends P₁ and P₂ to a payee. The payee creates a bearer token transaction (Unlock Secure Token) with P₁, and a new locking hash, H₃. If the payee wishes to consume the secure token then then H₃ = Hash(P₂| AccNumRec ) where P₂ was the pre-image received from the creator, and AccNumRec is the account number the payee wishes to have tokens transferred to.

If the payee wishes to transfer the secure token then H₃ = Hash(P₂ | H₄ | H₅ | RevBlk | AccNumSend ) where P₂ was the pre-image received from the creator, H₄ and H₅ are new locking hashes chosen by the payee, RevBlk, and AccNumSend will be the new reversion block and sending account, respectively, after the transfer is complete.

During processing, if Hash(P₁) = H₁, then nodes update locked secure bearer token record as follows: bearer token type is changed to unlocked secure bearer token; and H₁ is replaced with the new hash, H₃.

For a Consume Secure Token, the user who unlocked the secure bearer token creates and sends a consume unlocked secure bearer token transaction with the following: P₂; and a receiving account: AccNumRec. If during processing, Hash(P₂ ) = H₂, and Hash(P₂ | AccNumRec ) = H₁ (recall that H₁ = H₃ since it was replaced when the record change to unlocked) then nodes transfer the balance, less fees, to the receiving account provided in the transaction and remove the unlocked bearer token record from the ledger.

For a Transfer Secure Token transaction, the user who unlocked the secure bearer token creates and sends a transfer bearer token transaction with the following: P₂; two new hash digests, H₄ and H₅, from pre-images, P₄ and P₅, known only to the user; a new revert block number: RevBlk ; and a new sending account: AccNumSend. During processing, if Hash(P₂ ) = H₂, and Hash(P₂ | H₄ | H₅ | RevBlk | AccNumSend ) = H₁, then the record is updated again: the record type reverts to locked secure bearer token where, H₁= H₄, H₂ =H₅ and RevBlk and AccNumSend take the new values given in the transfer transaction.

As noted, transaction types may be associated with revert blocks, a future block number included in the transaction when the transaction is established. When such block number is processed, respective bearer token transactions that have yet to be consumed revert a balance (an amount) to the respective token creator. An administrative transaction, rather than a user originated transaction, is provided in accordance with the implementation embodiment.

For a Revert Bearer Token Balance transaction if the token is not consumed by the revert block number (RevBlk), each node automatically without any user request adds information to its revert bearer token administrative transaction line comprising: hash of the bearer token account record; balance being reverted (balance in the bearer token less fees charged for the reversion); and fees charged for the reversion. The result is the sending account is credited with the balance being reverted and the bearer token account record is removed from the ledger.

It may be observed by a person of ordinary skill in the art for bearer tokens and variants in accordance with proposed embodiments herein. For simple bearer tokens, the creator, the node that received the consume transaction, or anyone else with knowledge of P₁, could front-run by creating a consume transaction that made it into the blockchain before the one submitted by the intended payee. Bearer tokens are simple, intended for micropayments, but are not secure from bad users or nodes.

In the case of certified bearer tokens, it is also the case that anyone with knowledge of P₁ could also create a consume transaction before the payee. However, the receiving account is predesignated by the creator, so the intended payee receives the value regardless of who submits the consume transaction.

For secure bearer tokens, front-running is possible for an unlock transaction. However, only the creator and the payee know P₂, which is required to create a transaction (e.g. a valid transfer or consume and transfer or consume transaction). If the creator front-runs the payee on the unlock transaction, the payee will not be able to unlock the record. The payee will therefore know that the payee has not been paid and the token has not been transferred. Neither the payee nor the payer benefit in this case.

The node receiving the unlocking transaction knows P₁ and could create a valid lock transaction of its own. It does not know P₂, however, and so it could never create a valid transfer or consume transaction. Note that the payer or payee can’t transfer or consume the token either, since the node has supplied a new H₁. The result is the bearer token times out and reverts to the creator. The payee knows the token is unlockable by him, but the payer is unsure if the payee was the one that did nor did not unlock the token.

In all cases, bearer token creation requires an existing blockchain account and public key, which chain may comprise a Geeq chain in an embodiment. Consuming a bearer token requires a new or existing chain account to receive the proceeds, but does not require a signature.

Unlocking or transferring a secure bearer token does not require a chain account or public key. The account address given with a transfer transaction need not be real provided the new owner plans to consume or transfer the token before it reverts. This means that it would be possible for an intermediary to create secure bearer tokens and then transfer them in exchange for fiat or services to an agent without the agent knowing the intermediary’s identity even at the level of a chain account number. These tokens could then be transferred fully anonymously to other agents. In other words, secure bearer tokens function effectively as digital cash and do not require users to maintain private key stores.

Bearer tokens can be created in any amount, but they are non-fungible. They must be transferred or consumed as whole units. Fees are charged for creating, unlocking, transferring, and consuming bearer tokens, and so the value of a bearer token will slowly diminish if it is transferred multiple times.

### Multiple Signature (Multisig) Transactions

In accordance with techniques, methods and systems described and illustrated, there is provided multiple signature transactions, for example, whereby more than one signature is required to authorize the transaction. The following tables provide various record types and field descriptions therefor for a multisig transaction implementation in accordance with an embodiment. The tables include: multisig account record Table 10); unverified multisig create transaction (Table 11); and unverified multisig transaction (Table 12). Tables 10-12 show field names, meaning of such data fields and a “Count”. Count is one of “SR”, “SD” and “MR” where the letters “S”, “M”, “R”, and “D” mean, “single”, “multiple”, “required” and “depends on type”, respectively.

TABLE 10

Multisig Account Record

| | | |
|---|---|---|
| Designator | Meaning | Count |
| MultSigAccRec_G | Multisig Account Record | SR |
| BlkNum | ID number of record creation block | SR |
| BlkNum | ID number of last transaction block | SR |
| Nonce | The nonce required for the next valid transaction | SR |
| MultisigSigs | The number of signatures needed | SR |
| MultisigSigs | The number of authorized signers | SR |
| AccNumMultisig | One of the authorized account numbers | MR |
| ... | ... | |
| AmntBal | Balance in this user account | SR |
| AccNumMultisigMaster | Identifying master account number | SR |

TABLE 11

Unverified Multisig Create Transaction

| | | |
|---|---|---|
| Designator | Meaning | Count |
| UnVerMultisigCreateTrans_G | Unverified multisig create transaction | SR |
| BlkNum | ID number of the block target | SR |
| ChnNum | ID number of chain target | SR |
| NetActID | ID number of node target | SR |
| Nonce | Nonce of the funding account record | SR |
| MultisigSigs | The number of signatures needed | SR |
| MultisigSigs | Count of the exact number signatory account numbers | SR |
| AccNumMultisig | One of the account numbers authorized | MR |
| ... | | ... |
| AccNumMultisigMaster | Identifying master account number | SR |
| AccNumSend | User account number – User funding the account creation | SR |
| PubKeyUser | Public Key - User funding the account creation | SR |
| SigUser | Signature - User funding the account creation | SR |

TABLE 12

Unverified Multisig Transaction

| | | |
|---|---|---|
| Designator | Meaning | Count |
| UnVerMultisigTrans_G | Unverified multisig transaction | SR |
| BlkNum | ID number of the minimum block target | SR |
| BlkNum | ID number of the maximum block target | SR |
| ChnNum | ID number of chain target | SR |
| NetActID | ID number of node target | SR |
| Nonce | Nonce of the multisig account | SR |
| AmntTrans | Transaction amount | SR |
| AccNumRec | Receiving Account Number | SR |
| MultisigSigs | The number of public key/signature pairs included | SR |
| PubKeyUser | Public key of a signatory | MR |
| SigUser | Signature a signatory | MR |
| | | ... |
| AccNumMultisigMaster | Identifying master account number | SR |

In accordance with the implementation embodiment, a Multisig Create Transaction establishes a multisig account with a record (a multisig account record) in the ledger. The multisig account is funded out of AccNumSend if PubKeyUser and SigUser and nonce are correct. The sending account is charged the transaction amount and fees, and a multisig record record is created.

In an embodiment, the owner of the send account also chooses AccNumMultisigMaster, which is simply a hash of a random number. It serves only as an identifier, and is not used to check transaction validity.

The funding user chooses the number of signatories, the number required for a valid transaction, and who the signatories are. The funder may or may not be one of the signatories. In an embodiment there may be required fewer signatures required for a valid transaction than the number of signatories that may sign. For example, three signatories may have rights to sign but the signatures of any two maybe sufficient. In an embodiment, multisig master account numbers are unique - no collision.

For a Multisig Transaction, in an embodiment, the signatories do not need a chain user account, which chain may be a Geeqchain, in accordance with an embodiment. As with all account numbers, they are derived by taking the hash of any public key. They are validated by hashing a public key provided in an unverified transaction to verify a match, and then using the public key to verify the signature.

In an embodiment such as one using Table 11, all signatories use their multisig private key to cryptographically sign the following: BlkNum (min); BlkNum (max); ChnNum; NetActID; Nonce; AmntTrans; AccNumRec; and AccNumMultisigMaster (providing cryptographic signature). It will be understood that in some embodiments, multisig transaction data may include fewer data items. In an example, where only a single chain is available on the processing network, a chain number (ChnNum) need not be included. In an embodiment, basic payment related data may be a minimum requirement for a transaction. In an embodiment this transaction is enabled using a correct nonce.

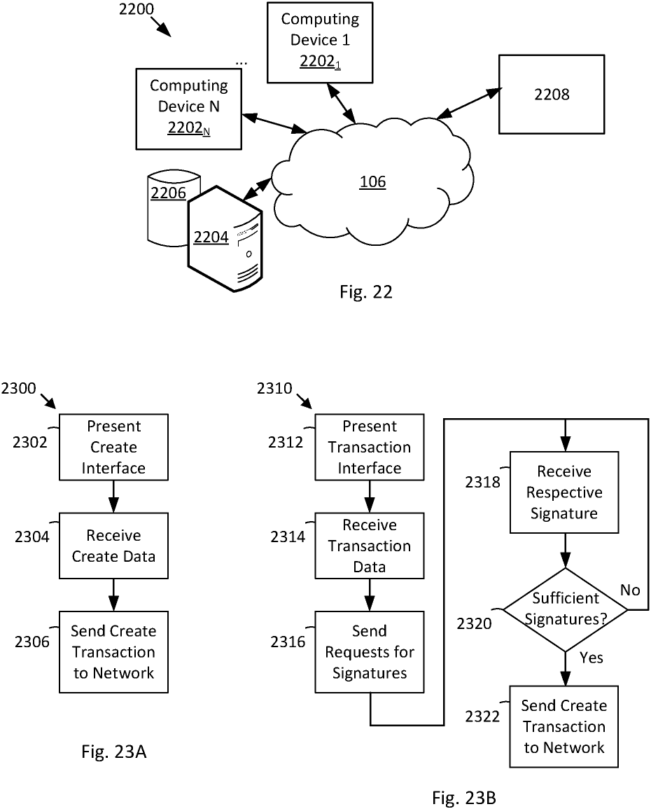

FIG. 22 is an illustration of a network system of a plurality of computing devices in accordance with an embodiment. Computing devices 2202₁ to 2202_{N} represent user computing devices that may participate in a multisig transaction, for example, via assistance of computing device 2204 having a data store 2206. In an embodiment, transaction network 2208 comprises a network implementing a blockchain for transaction processing including multisig create and multisig transaction processing. In an embodiment, network 2208 is a Geeqchain™ blockchain. Network 2208 may also implement bearer tokens such as is described herein and with reference to network 108 or others herein. In an embodiment, any of the computing devices 2202₁ to 2202_{N}, 2204 and those of network 2208 communicate via communication network 106, directly or indirectly.

In an embodiment, one of computing devices 2202₁ to 2202_{N} (e.g. computing device 2202₁) defines and communicates a transaction (e.g. a Multisig Create Transaction) to establish a multisig account to network 2208. Following processing in accordance with a consensus mechanism by network 2208, corresponding multisig account records are created in the network 2208 (e.g. at each node thereof). The transaction identifies the number of required signatures to authorized a valid transaction transferring an amount from the multisig account, the eligible signatories (those who validly can sign), etc. per the requirements of the multisig create transaction. The multisig account record is built accordingly.

To facilitate the establishment of a multisig transaction (e.g. to transfer from the multisig account) for processing by a node of the chain, in an embodiment, signatories send public key/signature pairs to a coordinating agent (possibly one of the signatories or a web application that puts together multisig transactions). In FIG. 22, computing device 2204 is configured to provide such an application/service, storing data to data store 2206. In an embodiment, the public key/signature pairs are sent from respective computing devices 2202₁ to 2202_{N} that are controlled by users who are eligible signatories on the multisig account.

Once a sufficient number of cryptographic signatures has been collected, the multisig transaction is constructed and sent for node processing (e.g. to a selected node for distribution in network 2208, in accordance with an embodiment). In one embodiment, the service provided by computing device 2204 (e.g. via respective interfaces) receives a request to create a new multisig transaction in relation to a multisig account from one of computing devices 2202₁ to 2202_{N}. In an embodiment, an authorization is confirmed to initiate the new transaction (e.g. two factor authentication or another manner). Multisig transaction data is provided by the initiating computing device (e.g. in accordance with Table 12). The web application/service communicates to eligible signatories to respectively sign the transfer transaction. Data store 2206 may include data to contact each eligible signatory. In an embodiment, communication between the service of computing device 2204 and any of the computing devices 2202₁ to 2202_{N} may be by way of a web application/web site and browser, a standalone application, In an embodiment, push notification to an on device standalone application or other communication (SMS, email, etc.) may be used to prompt a signatory to consider signing the incomplete transaction. Once a sufficient number of signatures is received (e.g. by service at computing device 2204), the transaction is ready for processing by network 2208.

As the facilitation of signature collection to establish the transaction is performed asynchronously and out-of-band (e.g. not via nodes of the network 2208 that maintains the ledger/chain per se), it may be prudent to select a block target to give time for coordination. The service offered by computing device 2204 may include providing data about the chain maintained by network 2208 to facilitate the definition of data for a multisig transaction. In an embodiment, the service may include defining a new multisig create transaction. However, all signatories must agree on the minimum and maximum block target (as well as other transaction parameters) for the transaction to be valid. In accordance with the embodiment, this transaction has multiple, non-nested signatures. In an embodiment, Schnorr signatures may be employed, as disclosed in U.S. Pat. 4,995,082 incorporated herein by reference.

FIGS. 23A and 23B are flowcharts of respective operations 2300 and 2310 of a computing device such as device 2204 in accordance with an embodiment. Operations 2300 perform a multisig create transaction service. At 2302, an interface is presented to a computing device (e.g. 2202₁) to facilitate the definition of a multisig create transaction for processing by network 2208. In an embodiment, the create transaction as in accordance with Table 11 for the establishment of a multisig account in network 2208 such as in accordance with the record of Table 10.

At 2304, multisig account establishing data (e.g. per requirements of Table 11) for the multisig create transaction is received via the interface. At 2306, the multisig create transaction is sent to network 2208 (e.g. to one of its nodes or via another coordinating device) to establish the multisig account record. In an embodiment, 2202₁ provides contact information for the eligible signatories. In an embodiment, eligible signatories are provided an interface by computing device 2204 to submit such information/update it, etc. to facilitate signature gathering. It will be understood that similar operations to operations 2300 are performed by an initiating computing device (e.g. 2202₁) when defining and communicating multisig account establishing data.

Operations 2310 provide a service to define and communicate a multisig transaction. At 2312 an interface is presented such as to one of computing devices 2202₁ to 2202_{N}. Transaction data (e.g. according to Table 12) is received. The service may present chain related data for network 2208 to facilitate selection/definition of some of the chain related data of the transaction. Multiple signatures are required and as such the transaction is incomplete.

At 2316, device 2204 sends requests to eligible signatories requesting signing of the incomplete transaction. At 2318 a respective signature is received (e.g. via a presented interface(not shown)). At 2320 a decision whether sufficient signatures are received is made. When insufficient, via No branch to 2318, operations await a further one or more signatures. If sufficient signatures are received, via Yes branch to 2322, operations send the signed transaction to network 2208 for processing.

In an embodiment, computing device 2204 communicates additional requests/reminder requests for signatures such as in response to results of step 2320 (not shown). It is understood that operations 2310 are not necessarily performed in the illustrated sequential order. Steps 2318 and 2320 may be differently ordered. Step 2320 may be performed prior to step 2318 and may trigger additional communications for signatures before a first signature is received from a device that did not initiate the transaction, as an example.

Operations 2310 are configured, in an embodiment, to communicate a status of signatures received to the initiator of the multisig transaction, for example, to prompt such user to request signatures from eligible signatories via a second communication channel (not shown). The status may indicate which signatories have signed.

Computing device 2204 may monitor block information from network 2208. Transactions that have not received sufficient signatures before the expiration of maximum block number may be closed in the service of computing device 2204 and the initiator so advised.

There is provided a method to establish a multiple signature (multisig) account in a blockchain ledger maintained by a network in which a plurality of signatures are required to authorize payment from the account. The method comprises: providing an interface to receive multisig account establishing data, the data comprising a plurality of eligible signatories and a minimum plurality of required signatures to authorize a payment transaction from the account; receiving the data; communicating the multisig account establishing data (e.g. as a create transaction) for processing by the network. Multisig account establishing data may be defined according to one or more requirements of Table 11.

There is provided a method to establish a multiple signature (multisig) transaction to make a payment from a multisig account in a blockchain ledger maintained by a network in which a plurality of signatures are required to authorize payment from the account. The method comprises: providing an interface to receive multisig transaction data, the data comprising a payment amount and a payment receiving account to receive the payment amount from the multisig account; receiving the transaction data; communicating one or more requests to eligible signatories to provide cryptographic signatures to complete the transaction; receiving a minimum number of required signatures in accordance with multisig account establishing data to complete the transaction; and communicating the multisig transaction for processing by the network. Multisig transaction data may be defined according to one or more requirements of Table 12. The method may comprise monitoring for a minimum number of required signatures. The method may comprise sending a reminder communication requesting a cryptographic signature in response to the monitoring. The method may comprise monitoring chain data (e.g. a current block number data) of the network and terminating an incomplete transaction (having insufficient cryptographic signatures) in response to the monitoring. In the method, the transaction data may specify a maximum block number by which processing of the transaction must be completed. In the method, should the chain data comprise a current block number which indicates the incomplete transaction, even if completed, would not be successfully processed, the incomplete transaction is terminated. In the method, processing to obtain remaining signatures is stopped if the incomplete transaction is terminated. In the method, transaction status (e.g. transaction completed and sent to the network, incomplete transaction terminated for insufficient signatures, etc.) is communicated to one or more of the initiator and eligible signatories.

Computer device and computer program product aspects are correspondingly associated with any of the method aspects herein and vice versa.

Practical implementation may include any or all of the features described herein. These and other aspects, features and various combinations may be expressed as methods, apparatus, systems, means for performing functions, program products, and in other ways, combining the features described herein. A number of embodiments have been described. Nevertheless, it will be understood that various modifications can be made without departing from the spirit and scope of the processes and techniques described herein. In addition, other steps can be provided, or steps can be eliminated, from the described process, and other components can be added to, or removed from, the described apparatus or systems. Accordingly, other embodiments are within the scope of the following claims.

Throughout the description and claims of this specification, the word “comprise”, “contain” and variations of them mean “including but not limited to” and they are not intended to (and do not) exclude other components, integers or steps. Throughout this specification, the singular encompasses the plural unless the context requires otherwise. In particular, where the indefinite article is used, the specification is to be understood as contemplating plurality as well as singularity, unless the context requires otherwise.

Features, integers, characteristics, or groups described in conjunction with a particular aspect, embodiment or example of the invention are to be understood to be applicable to any other aspect, embodiment or example unless incompatible therewith. All of the features disclosed herein (including any accompanying claims, abstract and drawings), and/or all of the steps of any method or process so disclosed, may be combined in any combination, except combinations where at least some of such features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

What is claimed is:

1. A computer-implemented method comprising steps performed by a processor and wherein the steps comprise:
communicating transaction data for performing a transaction by a transaction network to define a bearer token record;
wherein the transaction data comprises:
a sending account maintained by the transaction network from where an asset is to be transferred; and
a release hash digest computed from a release secret to associate with the record; and
wherein the bearer token record is completed by providing the release secret to the transaction network for use to match with the release hash and complete a transfer of the asset to a receiving account maintained by the transaction network.

2. The method of claim 1 comprising communicating the release secret to a receiver for providing to complete the bearer token record and transfer the asset to the receiving account.

3. The method of claim 2, wherein the release secret is defined as any of text and an encoded image.

4. The method of claim 1 comprising defining the transaction data.

5. The method of claim 4 comprising generating the release hash digest from the release secret to define the transaction data.

6. The method of claim 1, wherein the transaction to generate the bearer token record transfers the asset from the sending account to the bearer token record associated with the hash digest.

7. The method of claim 6, wherein the transaction data includes expiry data to establish an expiry time associated with the bearer token record at which expiry time the asset reverts to the sending account if the bearer token record is yet to be completed using the release secret.

8. The method of 1, wherein the transaction network requires no providing of the receiving account to generate the bearer token record.

9. The method of claim 1, wherein:
the bearer token record comprises a certified token record associated at generation of the certified token record with the receiving account; and
the transaction data further comprises the receiving account to which the asset is to be transferred.

10. The method of claim 1, wherein:
the bearer token record comprises a lockable bearer token record associated with a second hash digest;
the transaction data further comprises the second hash digest computed from a holding secret for locking the lockable bearer token record to the receiving account, wherein to complete the locking requires providing to the transaction network the holding secret and account information for the receiving account to lock the lockable bearer token record so that only a single agent is enabled to complete the lockable bearer token record.

11. The method of claim 1, wherein the transaction is signed by a private key associated with the sending account.

12. The method of claim 1, wherein the transaction network processes transactions and stores transaction records including bearer token records in accordance with a blockchain consensus protocol.

13. The method of claim 1, wherein the asset comprises any of a crypto asset maintained by the transaction network; and an amount of a currency defined to satisfy a micro-transaction.

14. A computer implemented method comprising steps performed by a processor and wherein the steps comprise:
communicating, to a transaction network, transaction data for a transaction to complete a bearer token record to transfer an asset to a receiving account, the bearer token record and receiving account maintained by the transaction network, wherein:
the bearer token record is associated with: the asset to be transferred; and a release hash digest computed from a release secret; and
the transaction data comprises the release secret for use to match to the release hash digest to complete the transfer.

15. The method of claim 14, wherein the bearer token record is further associated with a sending account from where the asset was received for the bearer token.

16. The method of claim 14 comprising receiving the release secret for providing to complete the bearer token record.

17. The method of claim 14, wherein:
the bearer token record comprises a certified token record; and
the certified token record is further associated with the receiving account at generation of the certified token.

18. The method of claim 14, wherein:
the bearer token record comprises a lockable bearer token record; and
the lockable bearer token record is further associated at generation of the lockable bearer token record with a second hash digest computed from a holding secret for subsequently locking the lockable bearer token record to the receiving account maintained by the transaction network; and
the method comprises:
communicating locking transaction data to lock the lockable bearer token record, the locking transaction data comprising the holding secret and account information for the receiving account so that only a single agent is enabled to complete the lockable bearer token.

19. The method of claim 16, wherein the transaction is unsigned by a private key associated with the receiving account maintained by the transaction network to which the asset is to be transferred.

20. A computing device comprising circuitry configured to:
communicate transaction data for performing a transaction by a transaction network to define a bearer token record;
wherein the transaction data comprises a sending account maintained by the transaction network from where the asset is to be transferred; and a release hash digest computed from a release secret to associate with the record; and
wherein the bearer token record is completed by providing the release secret to the transaction network for use to match with the release hash and complete a transfer of the asset to a receiving account maintained by the transaction network.

21. The computing device of claim 20 further configured to provide a cryptocurrency wallet comprising cryptographic keys with which to manage a blockchain account, the keys useful to define the sending account and sign the transaction; and wherein the cryptocurrency wallet provides:
an interface to receive release secrets; and
a hash function to compute release hash digests from release secrets to define transaction data for transactions to generate bearer token records.

22. The computing device of claim 21, wherein the cryptocurrency wallet provides each of: i) an interface to communicate the release secret; and an interface to receive a release secret for a bearer token record previously generated by the transaction network and the computing device is configured to communicate to the transaction network completing data for a completing transaction to complete the bearer token record, the completing data comprising the release secret for the bearer token record previously generated and receiving account information.
